(19) United States
(12) Patent Application Publication
(10) Pub. No.: US 2021/0157523 A1
(43) Pub. Date: May 27, 2021

(54) STORAGE SYSTEM

(71) Applicant: HITACHI, LTD., Tokyo (JP)

(72) Inventors: Takaki Matsushita, Tokyo (JP); Tomohiro Kawaguchi, Tokyo (JP); Ai Satoyama, Tokyo (JP)

(73) Assignee: HITACHI, LTD., Tokyo (JP)

(21) Appl. No.: 16/801,880

(22) Filed: Feb. 26, 2020

(30) Foreign Application Priority Data
Nov. 21, 2019 (JP) 2019-210899

(51) Int. Cl. G06F 3/06

(52) U.S. Cl. CPC G06F 3/0659; G06F 3/0673; G06F 3/0619

(57) ABSTRACT

A storage system capable of appropriately restoring a logical volume is provided.

A storage system capable of restoring a logical volume, including: a data control section that exercises control to additionally write data at a past point in time in the logical volume to a storage section; and a data management section that manages metadata about the data additionally written to the storage section by the data control section, the metadata being data for associating position information about the data in the logical volume with position information about the data in the storage section, and the data management section copying metadata at a predetermined point in time of issuance of a restore operation for the logical volume to the logical volume, and returning the logical volume into a state at the predetermined point in time.

### BACKGROUND OF THE INVENTION

### 1. Field of the Invention

The present invention relates to a storage system and is suited to be applied to, for example, a storage system capable of restoring a logical volume.

### 2. Description of the Related Art

When data tampering, data failure, or the like caused by ransomware or the like occurs, it is required to promptly recover (restore) data. For example, there is known a continuous data protection (CDP) technique for holding update histories so that data can be returned into an arbitrary state before tampering.

As for the CDP, a technique for searching a designated point of time in an inverse order of a write order and restoring a production volume to a past designated point in time (refer to U.S. Pat. No. 9,946,606).

According to the technique described in U.S. Pat. No. 9,946,606, data in a logical volume is saved per se. This disadvantageously causes an increase in overhead due to data movement and deteriorations in an input/output (I/O) performance, a restore performance, and the like.

### SUMMARY OF THE INVENTION

The present invention has been achieved in the light of the above respects, and an object of the present invention is to propose a storage system capable of appropriately restoring a logical volume.

To attain the object, a storage system according to an aspect of the present invention is a storage system capable of restoring a logical volume, including: a data control section that exercises control to additionally write data at a past point in time in the logical volume to a storage section; and a data management section that manages metadata about the data additionally written to the storage section by the data control section, the metadata being data that associates position information about data in the logical volume with position information about the data in the storage section, and the data management section copying metadata at a predetermined point in time of issuance of a restore operation for the logical volume to the logical volume, and returning the logical volume into a state of the predetermined point in time.

With the configuration described above, operating the metadata enables the logical volume to be returned into the state of a past point in time without moving data in the logical volume; thus, it is possible to promptly recover data into a user's desired state even in a case, for example, of occurrence of a data failure. Furthermore, with the configuration described above, managing the metadata about past data makes it possible to restore the logical volume into a past other point in time even in a case, for example, in which a user restores the logical volume into a past certain point in time.

According to the present invention, it is possible to realize highly reliable storage system.

### BRIEF DESCRIPTION OF THE DRAWINGS

FIG. 1 is an explanatory diagram of an outline of a computing machine system according to a first embodiment;

FIG. 2 depicts an example of a configuration related to the computing machine system according to the first embodiment;

FIG. 3 depicts an example of a configuration of a memory and programs and management information within the memory according to the first embodiment;

FIG. 4 depicts an example of a configuration of metadata according to the first embodiment;

FIG. 5 depicts an example of a relationship among logical addresses according to the first embodiment;

FIG. 6 depicts an example of a state transition in a storage system according to the first embodiment;

FIG. 7 is an explanatory diagram of an outline of data deduplication according to the first embodiment;

FIG. 8 depicts an example of a VOL management table according to the first embodiment;

FIG. 9 depicts an example of an address translation table according to the first embodiment;

FIG. 10 depicts an example of an effective area management table according to the first embodiment;

FIG. 11 depicts an example of a page translation table according to the first embodiment;

FIG. 12 depicts an example of a page allocation management table according to the first embodiment;

FIG. 13 depicts an example of a sub-block management table according to the first embodiment;

FIG. 14 depicts an example of an additional write destination search table according to the first embodiment;

FIG. 15 depicts an example of a duplication check table according to the first embodiment;

FIG. 16 depicts an example of a hash management table according to the first embodiment;

FIG. 17 depicts an example of a duplication management table according to the first embodiment;

FIG. 18 depicts an example of a common area allocation management table according to the first embodiment;

FIG. 19 depicts an example of a common area check table according to the first embodiment;

FIG. 20 depicts an example of a flow of a read process according to the first embodiment;

FIG. 21 depicts an example of a flow of a front-end write process according to the first embodiment;

FIG. 22 depicts an example of a flow of a data volume reduction process according to the first embodiment;

FIG. 23 depicts an example of a flow of a deduplication process according to the first embodiment;

FIG. 24 depicts an example of a flow of a duplication determination process according to the first embodiment;

FIG. 25 depicts an example of a flow of an additional write process according to the first embodiment;

FIG. 26 depicts an example of a flow of a restore process according to the first embodiment;

FIG. 27 depicts an example of a flow of a definitive determination process according to the first embodiment;

FIG. 28 depicts an example of a flow of an Undo process according to the first embodiment;

FIG. 29 depicts an example of a flow of a purge process according to the first embodiment;

FIG. 30 depicts an example of a flow of a garbage collection process according to the first embodiment; and

FIG. 31 depicts an example of a flow of a common area release process according to the first embodiment.

### DESCRIPTION OF THE PREFERRED EMBODIMENTS

Embodiments of the present invention will be described hereinafter with reference to the drawings.

In the following description, an “interface section” may be one or more interfaces. The one or more interfaces may be one or more communication interfaces of the same type (for example, one or more network interface cards (NIC)) or may be two or more communication interfaces of different types (for example, the NIC and a host bus adapter (HBA)).

Furthermore, in the following description, a “memory section” is one or more memories and may typically be a main storage device. At least one memory in the memory section may be either a volatile memory or a nonvolatile memory.

Moreover, in the following description, a “PDEV section” is one or more PDEVs and may be typically an auxiliary storage device. “PDEV” means a physical storage device and is typically a nonvolatile storage device, which is, for example, a hard disk drive (HDD) or a solid state drive (SSD).

Furthermore, in the following description, a “storage section” is at least one of at least part of the memory section and the PDEV section (typically, at least the memory section).

Further, in the following description, a “processor section” is one or more processors. While the at least one processor is typically a microprocessor such as a central processing unit (CPU), the at least one processor may be a processor of the other type such as a graphics processing unit (GPU). The at least one processor may be either a single core processor or a multicore processor.

The at least one processor may be a processor in a broad sense such as a hardware circuit (for example, a field-programmable gate array (FPGA) or an application specific integrated circuit (ASIC)) that performs part of or entirety of processes.

Moreover, in the following description, information is often described using an expression such as “xxx table”; however, this information may be data of any structure and may be a learning model such as a neural network that generates an output in response to an input. Therefore, the “xxx table” can be rephrased as “xxx information.”

Further, in the following description, a configuration of each table is exemplarily depicted and one table may be divided into two or more tables, and all of or part of the two or more tables may be one table.

Furthermore, in the following description, a process is often described with “program” used as a subject; however, the subject of the process may be the processor section (or a device such as a controller having such a processor section) since a specified process is performed using the memory section and/or the interface section as appropriate by executing the program by the processor section.

The program may be installed in a device such as a computing machine, and may be present in, for example, a program distribution server or a computing machine-readable (for example, non-transitory) recording medium. Moreover, in the following description, two or more programs may be realized as one program or one program may be realized as two or more programs.

Further, in the following description, a “computing machine system” is a system that includes one or more physical computing machines. The physical computing machine may be either a general-purpose computing machine or a dedicated computing machine. The physical computing machine may function as a computing machine (for example, host computing machine) that issues an I/O request, or may function as a computing machine (for example, storage device) that performs I/O of data in response to the I/O request.

In other words, the computing machine system may be at least one of a host system that is one or more host computing machines each issuing an I/O request and a storage system that is one or more storage devices each performing I/O of data in response to the I/O request. In at least one physical computing machine, one or more virtual computing machines (for example, Virtual Machines (VM)) may be executed. The virtual computing machine may be a computing machine issuing an I/O request or a computing machine performing I/O of data in response to the I/O request.

Furthermore, the computing machine system may be a distributed system configured with one or more (typically, a plurality of) physical node devices. The physical node device is a physical computing machine.

Moreover, by causing a physical computing machine (for example, node device) to execute predetermined software, software-defined anything (SDx) may be constructed in the physical computing machine or a computing machine system including the physical computing machine. Examples of the SDx that can be adopted include a software defined storage (SDS) and a software-defined datacenter (SDDC).

For example, a storage system serving as the SDS may be construct by executing software having a storage function by a physical general-purpose computing machine.

Furthermore, at least one physical computing machine (for example, storage device) may execute one or more virtual computing machines as a host system and a virtual computing machine as a storage controller (typically, a device that inputs/outputs data to/from a PDEV section in response to an I/O request) in a storage system.

In other words, such at least one physical computing machine may have both of a function as at least part of the host system and a function as at least part of the storage system.

In addition, the computing machine system (typically, storage system) may have a redundant configuration group. A redundant configuration may be a configuration with a plurality of node devices based on Erasure Coding, a redundant array of independent nodes (RAIN), inter-node mirroring, or the like, or may be a configuration with a single computing machine (for example, node device) such as one or more redundant array of independent (or inexpensive) disks (RAID) groups serving as at least part of the PDEV section.

Furthermore, in the following description, a “dataset” is one chunk of logical electronic data from a view of a program such as an application program, and may be any of, for example, a record, a file, a key-value pair, and a tuple.

Moreover, in the following description, an identification number is used as identification information about each of various objects; however, other types of identification information (for example, an identifier containing alphabets and symbols) may be used as the identification information.

Moreover, in the following description, in a case of describing each of elements of the same type without discrimination, a common part (part other than a branch number) out of a reference character including the branch number is often used, and in a case of describing each the elements of the same type while discriminating the elements, a reference character including a branch number is often used. For example, in a case of describing data without specific discrimination, notation such as “data 111” is often used, and in a case of describing data while discriminating individual data, notation such as “data 111-1” or “data 111-2” is often used.

### (1) First Embodiment

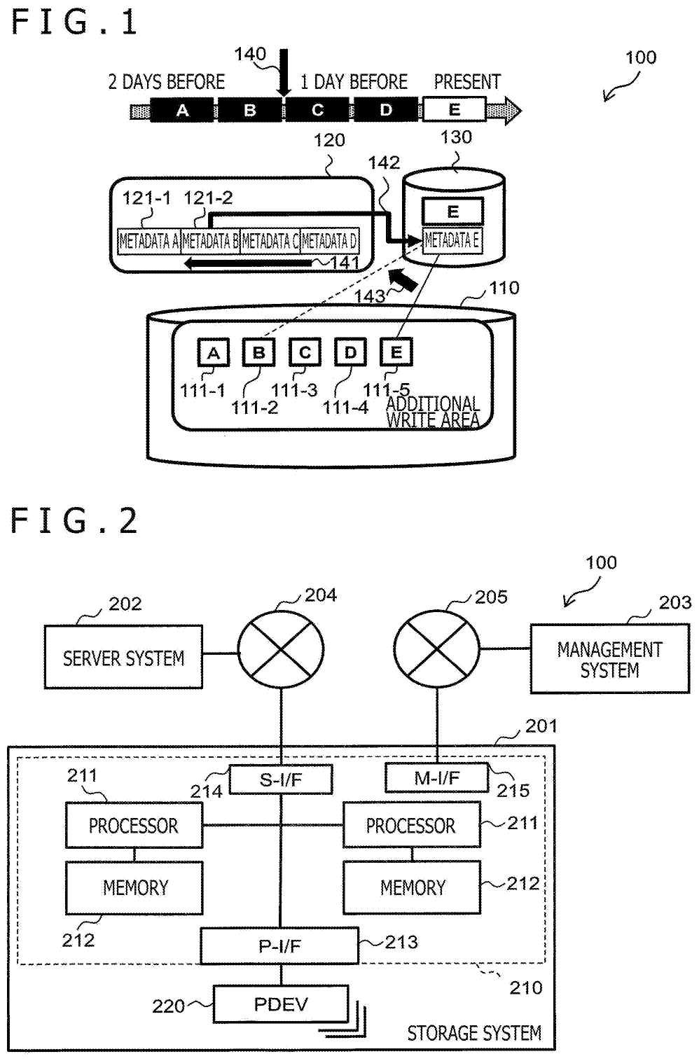

In FIG. 1, reference character 100 wholly denotes a computing machine system according to a first embodiment.

FIG. 1 is an explanatory diagram of an outline of the computing machine system 100.

The computing machine system 100 is configured with a pool volume 110 that is a logical volume capable of additionally writing data 111, a data processing section 120 that manages metadata 121 about the data 111, and a normal volume 130 that is a logical volume distributed to a host device.

The metadata 121 is data for associating position information about the data 111 in the normal volume 130 with position information about the data 111 in the pool volume 110. The metadata 121 is, for example, data for making referent information about the data 111 correspond to time information about time of updating (writing) the data 111. The referent information contains position information with which a position of the data 111 in the normal volume 130 can be identified and position information with which a position of the data 111 in the pool volume 110 can be identified.

In the computing machine system 100, data A (data 111-1), for example, is updated to data B (data 111-2), metadata A (metadata 121-1) is saved and data B is additionally written to the pool volume 110. More specifically, when the data A is updated to the data B, then the metadata A is saved in a predetermined storage area as the metadata 121 in which the time information is added to the referent information about the data A by the data processing section 120, and the data B is additionally written to the pool volume 110 without overwriting the data A.

In such a computing machine system 100, the metadata 121 is rewound to past time (referred to as “restore designated time,” which is restore designated time 140 in the present example) to which it is designated to restore the normal volume 130 (process 141), the rewound metadata 121 is copied to the normal volume 130 (process 142), and a referent of the data 111 is changed over (process 143).

In the example of FIG. 1, the data 111 is updated to data A, data B, data C (data 111-3), data D (data 111-4), and data E (data 111-5) in this order, and the data E is currently referred to in the normal volume 130.

For example, in a case of returning the normal volume 130 into a state of the restore designated time 140 (in a case of restoring the normal volume 130), in the computing machine system 100, metadata B (metadata 121-2) about the data B at the restore designated time 140 is first identified by tracking the time information about the metadata 121. In addition, the metadata B is copied to the normal volume 130 and the referent of the data 111 is changed to the data B, whereby the normal volume 130 is returned into the state at a point in time of the restore designated time 140.

The data 111 additionally written to the pool volume 110 herein may be a data unit (dataset) to be additionally written or may be a snapshot that stores the state of the normal volume 130 at a given point in time. It is noted that the present embodiment will be described while taking a case of continuously leaving datasets by way of example.

Furthermore, other volumes (for example, a CDP data volume 430 to be described later and a common volume 730 to be described later) may be disposed between the pool volume 110 and the normal volume 130. The other volumes can enhance, for example, an 10 performance. It is noted that the present embodiment will be described while taking a case of disposing the other volumes therebetween by way of example.

FIG. 2 depicts an example of a configuration related to the computing machine system 100.

The computing machine system 100 is configured with a storage system 201, a server system 202, and a management system 203. The storage system 201 and the server system 202 are connected to each other via a Fibre channel (FC) network 204. The storage system 201 and the management system 203 are connected to each other via an internet protocol (IP) network 205. It is noted that the FC network 204 and the IP network 205 may be an identical communication network.

The storage system 201 is configured with one or more storage controllers 210 and one or more PDEVs 220. One PDEV 220 is connected to one storage controller 210.

Each storage controller 210 is configured with one or more processors 211, one or more memories 212, a P-I/F 213, an S-I/F 214, and an M-I/F 215.

Each processor 211 is an example of a processor section. The processor 211 may include a hardware circuit that performs compression and decompression. In the present embodiment, the processor 211 performs restore-related control, compression and decompression, data deduplication, and the like.

The memory 212 is an example of a storage section. The memory 212 stores programs executed by the processor 211, data used by the processor 211, and the like. The processor 211 executes each program stored in the memory 212. It is noted that a set of the memory 212 and the processor 211 is, for example, duplexed.

The P-I/F 213, the S-I/F 214, and the M-I/F 215 are an example of an interface section.

The P-I/F 213 is a communication interface device that mediates communication of data between the PDEV 220 and the storage controller 210. A plurality of PDEVs 220 are connected to the P-I/F 213.

The S-I/F 214 is a communication interface device that mediates communication of data between the server system 202 and the storage controller 210. The server system 202 is connected to the S-I/F 214 via the FC network 204.

The M-I/F 215 is a communication interface device that mediates communication of data between the management system 203 and the storage controller 210. The management system 203 is connected to the M-I/F 215 via the IP network 205.

The server system 202 is configured with one or more host devices. The server system 202 (host device) transmits an I/O request (write request or read request), in which an I/O destination (for example, a logical volume number such as a logical unit number (LUN) or a logical address such as a logical block address (LBA)) is designated, to the storage controller 210.

The management system 203 is configured with one or more management devices. The management system 203 (management device) manages the storage systems 201.

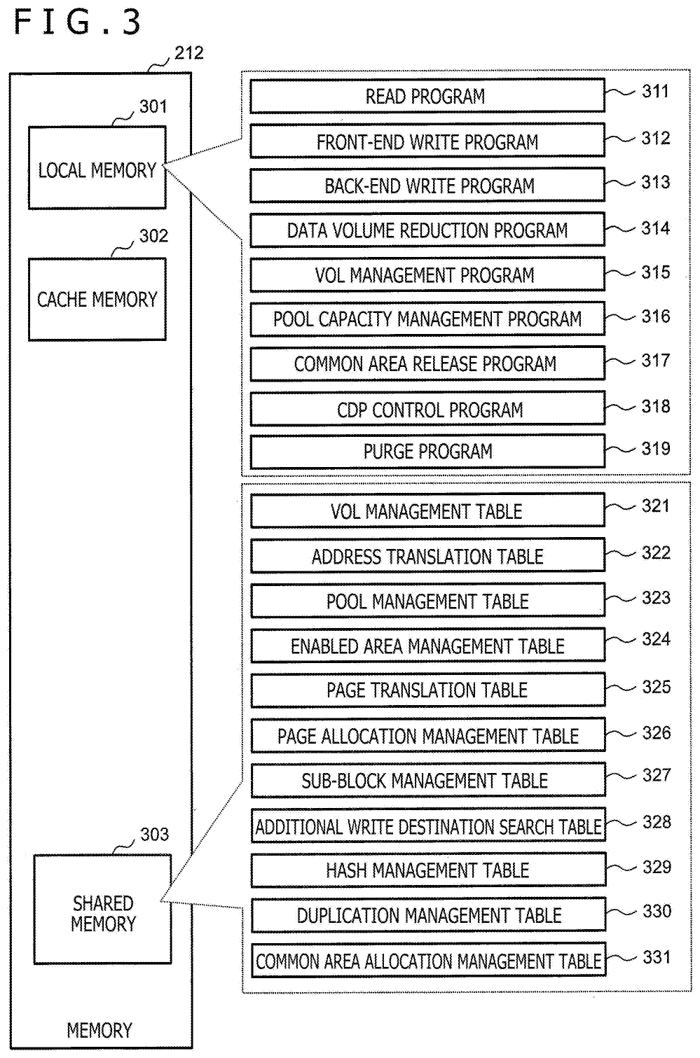

FIG. 3 depicts an example of a configuration of each memory 212 and programs and management information within the memory 212.

The memory 212 includes memory areas such as a local memory 301, a cache memory 302, and a shared memory 303. Among these memory areas, at least one memory area may be an independent memory. The local memory 301 is used by the processor 211 that belongs to the same set as that to which the memory 212 including this local memory 301 belongs.

The local memory 301 stores therein a read program 311, a front-end write program 312, a back-end write program 313, a data volume reduction program 314, a VOL management program 315, a pool capacity management program 316, a common area release program 317, a CDP control program 318, and a purge program 319. These programs will be described later.

The cache memory 302 temporarily stores therein datasets to be written or read to or from the PDEV 220.

The shared memory 303 is used by both of the processor 211 that belongs to the same set as that to which the memory 212 including this shared memory 303 belongs to and the processor 211 that belongs to a different set. The shared memory 303 stores therein management information.

The management information includes a VOL management table 321, an address translation table 322, a pool management table 323, an enabled area management table 324, a page translation table 325, a page allocation management table 326, a sub-block management table 327, an additional write destination search table 328, a hash management table 329, a duplication management table 330, and a common area allocation management table 331.

Among these tables, those other than the pool management table 323 will be described later with reference to the drawings. The pool management table 323 is a table that holds information associated with a pool volume 440 to be described later.

The pool management table 323 holds, for example, per pool volume 440, information about a pool # (number of the pool volume 440), RG # (number of one or more RAID groups that form basis of the pool volume 440), a pool capacity (capacity of the pool volume 440), and a pool used capacity (capacity used out of the pool capacity (typically, total capacity of allocated pages among the pool volume 440)).

FIG. 4 depicts an example of a configuration of metadata (metadata 400).

In the storage system 201, CDP is realized by one or more CDP volumes 420 each of which is a logical volume distributed to the server system 202 and each of which is identified (designated) by one LUN 410, the CDP data volume 430 that is a logical volume managing data about the one or more CDP volumes 420, the pool volume 440 that is a logical volume storing data about the CDP volumes 420, and a CDP metadata volume 450 that manages a correspondence relationship between data in the CDP volumes 420 and the CDP data volume 430 as the metadata 400.

The pool volume 440 is configured with a plurality of pages 461. For example, a given logical address space in the pool volume 440 is allocated to each page 461, and logical data 462 is disposed (stored) in the page 461. While an entity (actual data) of the logical data 462 is stored in the PDEV 220 via a virtual device (VDEV) 570 to be described later, the PDEV 220 is not depicted in FIG. 4. It is noted that FIG. 4 illustrates an example in which compressed data (expressed by a lower-case character) is stored in the PDEV 220.

The CDP data volume 430 is configured with referent information 463 as information for referring to each page 461. Each referent information 463 is configured with position information with which a position of a logical address space 464 in which each page 461 is to be disposed can be identified in the CDP data volume 430 and position information with which a position of the page 461 can be identified in the pool volume 440.

Each CDP volume 420 is configured with referent information 465 as information for referring to the logical data 462. The referent information 465 is configured with position information with which a position of a logical address space 466 in which each logical data 462 is to be disposed can be identified in each CDP volume 420 and position information with which a position of a logical address space 464 in which the logical data 462 is to be disposed can be identified in the CDP data volume 430. The referent information 465 stores therein, for example, information about the address translation table 322.

In the storage system 201, when the actual data of the logical data 462 is updated, the metadata 400 in which time information about time of write is added to the referent information 465 is saved to the CDP metadata volume 450. In the storage system 201, referring to the metadata 400 makes it possible to identify a write order (more properly, additional write execution order) of the actual data of the logical data 462.

The metadata 400 is configured with SEQ #401, WR time 402, CDPVOL-LDEV #403, CDPVOL-LBA 404, CDPDATAVOL position information 405, and CDPVOL-LDEV-SLOT #406.

The SEQ #401 is a sequence number for identifying the metadata 400. The WR time 402 is time at which the actual data is written. The CDPVOL-LDEV #403 is a number (LDEV ID) of the CDP volume 420. The CDPVOL-LBA 404 is a logical address (that is, logical address of the logical address space 466) for managing where the logical data 462 about the actual data is written in the CDP volume 420. The CDPDATAVOL position information 405 is a logical address (that is, logical address of CVDEV 530 to be described later) for managing where the logical data 462 about the actual data is written in the CDP data volume 430. Additionally, a relationship of the referent information 465 is identified by the CDPVOL-LBA 404 and the CDPDATAVOL position information 405. The CDPVOL-LDEV-SLOT #406 is a number for identifying a unit into which the CDP volume 420 is demarcated by 256 KB (kilobytes).

In the storage system 201, continuously leaving data per write (continuously leaving old data that is data before update by an additional write function) and changing over the metadata 400 make it possible to reconstruct old data at the restore designated time to the CDP volume 420. Furthermore, with such a configuration, the storage system 201 can reconstruct the old data at the restore designated time to the logical volume other than the CDP volumes 420 and perform an operation check before reconstructing the old data to the CDP volume 420.

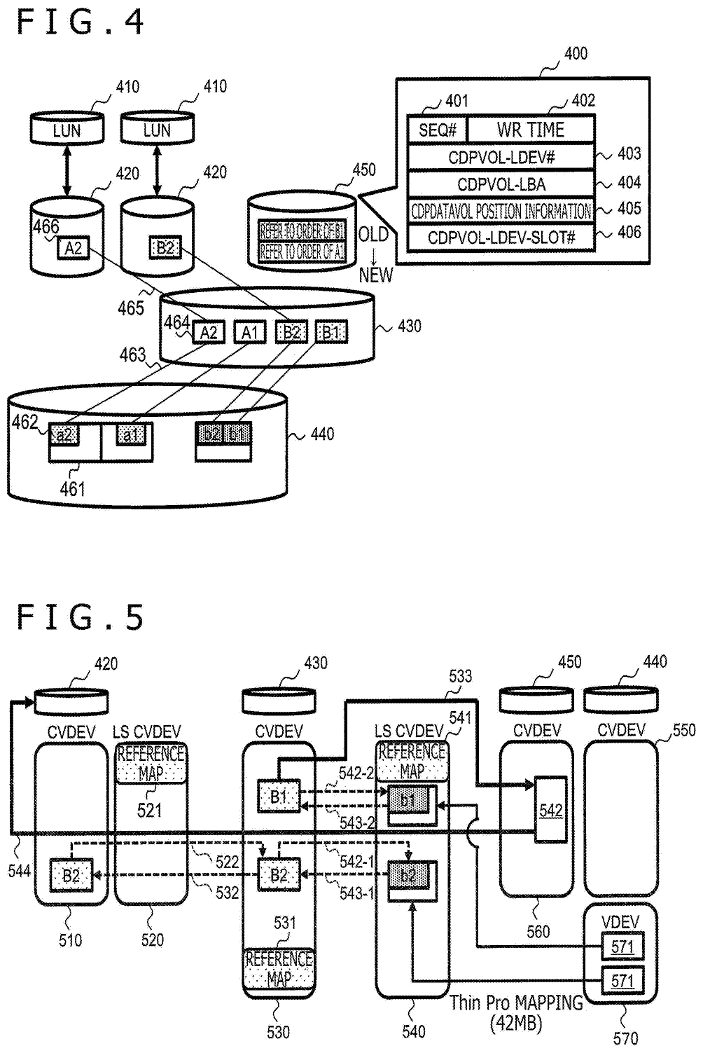

FIG. 5 depicts an example of a relationship of logical addresses.

Each CDP volume 420 is configured with a cache VDEV (CVDEV) 510 and a log structured (LS) CVDEV 520 as constituent elements. A “CVDEV” is a unit (logical area) for managing the cache memory 302 and can be handled as, for example, a logical volume. An “LSCVDEV” is a logical area necessary for data compression and the like and can be handled as a logical volume. The CDP data volume 430 is configured with a CVDEV 530 and an LSCVDEV 540 as constituent elements. The pool volume 440 is configured with a CVDEV 550 as a constituent element. The CDP metadata volume 450 is configured with a CVDEV 560 as a constituent element.

The LSCVDEV 520 stores therein a reference map 521. The reference map 521 contains referent information 522 for forward reference. The referent information 522 for the forward reference is used, for example, in a data 10 process. The referent information 522 is information indicating that a logical address of data (logical data) managed in the CDP volume 420 on the CVDEV 510 refers to a logical address of the data (logical data) managed in the CDP data volume 430 on the CVDEV 530.

The CVDEV 530 stores therein a reference map 531. The reference map 531 contains information for reverse reference. The information for the reverse reference is reverse reference information for managing from where the logical address of the CVDEV 530 in the CDP data volume 430 is referred to, and contains, for example, referent information 532 and 533. The referent information 532 is used, for example, in a deduplication process to be described later and a common area release process to be described later. The referent information 532 is information indicating that a logical address of data (logical data) managed in the CDP data volume 430 on the CVDEV 530 refers to a logical address of the data (logical data) managed in the CDP data volume 420 on the CVDEV 510. The referent information 533 is information indicating that a logical address of past data (logical data) managed in the CDP data volume 430 on the CVDEV 530 refers to a logical address of referent information 542 about the past data (logical data) managed in the CDP metadata volume 450 on the CVDEV 560.

The LSCVDEV 540 stores therein a reference map 541. The reference map 541 contains the referent information 542 for the forward reference, referent information 543 for the reverse reference, and referent information 544 for use in a restore process to be described later.

It is noted that the reference maps 521 and 541 are realized by the address translation table 322. The reference map 531 is realized by the duplication management table 330.

The referent information 542 is information indicating that a logical address of the data (logical data) managed in the CDP data volume 430 on the CVDEV 530 refers to a logical address of the data (logical data) on the LSCVDEV 540. The referent information 543 is information paired with the referent information 542 and indicating that a logical address of the data (logical data) managed in the CDP data volume 430 on the LSCVDEV 540 refers to a logical address of the data (logical data) managed in the CDP data volume 430 on the CVDEV 530.

The referent information 544 is information for managing what logical address in what CDP volume 420 the saved metadata is saved to. The referent information 544 is information corresponding to the CDPVOL-LDEV #403 and CDPVOL-LBA 404. The referent information 544 is information indicating that a logical address of the referent information 542 about past data (logical data) managed in the CDP metadata volume 450 refers to a logical address (LBA) of the past data (logical data) in the CDP volume 420.

The CVDEV 560 stores therein the referent information 542 about the past data (logical data). The VDEV 570 is a unit for handling a plurality of PDEVs 220 configuring a RAID parity group as one. One page 461 in the pool volume 440 is allocated to a page 571 in the VDEV 570 by Thin Provisioning (ThinPro mapping), so that data on the PDEV 220 can be referred to by the LSCVDEV 540 via the VDEV 570 and the pool volume 440.

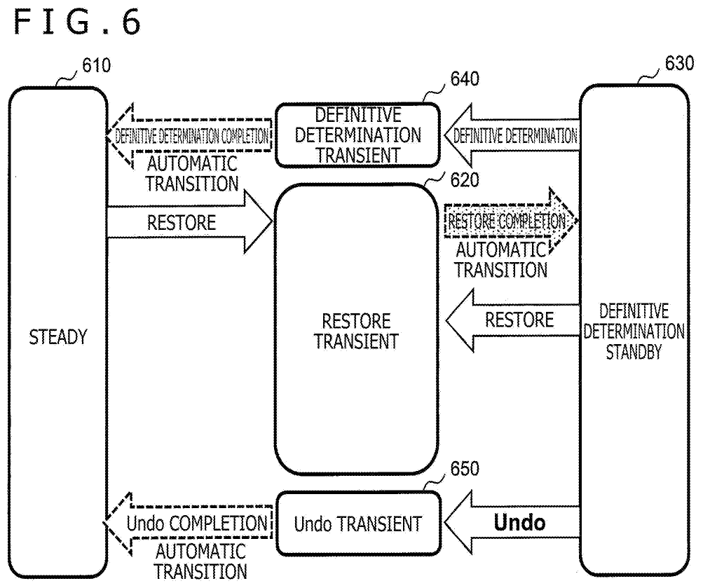

FIG. 6 depicts an example of a state transition of the CDP volume 420 in the storage system 201.

As states of the CDP volume 420, a steady state 610, a restore transient state 620, a definitive determination standby state 630, a definitive determination transient state 640, and an Undo transient state 650 are set.

The steady state 610 is also a state in which ordinary work is carried out and in which data is protected. In a case, for example, of occurrence of a data failure in the steady state 610, the steady state 610 transitions to the restore transient state 620 on an opportunity of a restore operation.

The restore transient state 620 is a state in which the restore process to be described later is performed. On an opportunity of completion of the restore process, the restore transient state 620 transitions to the definitive determination standby state 630.

The definitive determination standby state 630 is a state in which a user can confirm a state at which point in time it is appropriate to return data to when the CDP volume 420 is to be returned to past data. On an opportunity of a restore operation, the definitive determination standby state 630 transitions to the restore transient state 620. In addition, on an opportunity of a restore definitive determination operation, the definitive determination standby state 630 transitions to the definitive determination transient state 640. In addition, on an opportunity of an operation to return a state after restore to a state before restore (Undo operation), the definitive determination standby state 630 transitions to the Undo transient state 650.

Generally in a case of CDP, a past point in time to which the data is to be restored is less clear at a time of restore and recovery from the data failure, and it is necessary to repeat restoring the data a plurality of times and search an appropriate past point in time. It is supposed from this fact that an operation of definitively determining restore data at a point in time that can be determined to be appropriate is adopted. Nevertheless, according to the conventional technique, when the state of the CDP volume 420 is returned into the state at the past designated point in time, a past point in time at which the data can be restored again is older than a past point in time designated in last restore. In this respect, in the storage system 201, providing the definitive determination standby state 630 enables the user to perform any number of times restoring the state of the CDP volume 420 to that at a desired pas point in time and confirming the state of the CDP volume 420.

Here, whether data is restored in a logical volume other than the CDP volume 420 or data is directly restored in the CDP volume 420, then data is continuously, additionally written and left by writing data to the CDP volume 420 in the definitive determination standby state 630, resulting in overflow of the CDP metadata volume 450. In other words, even in a case in which data is restored again in the CDP volume 420 at a different point in time, old metadata is erased from the CDP metadata volume 450 by writing data; thus, old data is impossible to access. For the above reason, it is necessary to set a limitation to the effect that “data cannot be written to the CDP volume 420” or “data can be written to the CDP volume 420 but metadata is not saved to the CDP metadata volume 450 in the definitive determination standby state 630.” In this respect, in the storage system 201, metadata is not saved to the CDP metadata volume 450 by writing data in the definitive determination standby state 630; thus, data may be permitted to be written to the CDP volume 420 for which data is definitively determined.

The definitive determination transient state 640 is a state in which a definitive determination process to be described later is performed. On an opportunity of completion of the definitive determination process, the definitive determination transient state 640 transitions to the steady state 610.

The Undo transient state 650 is a state in which an Undo process to be described later is performed. On an opportunity of completion of the Undo process, the Undo transient state 650 transitions to the steady state 610.

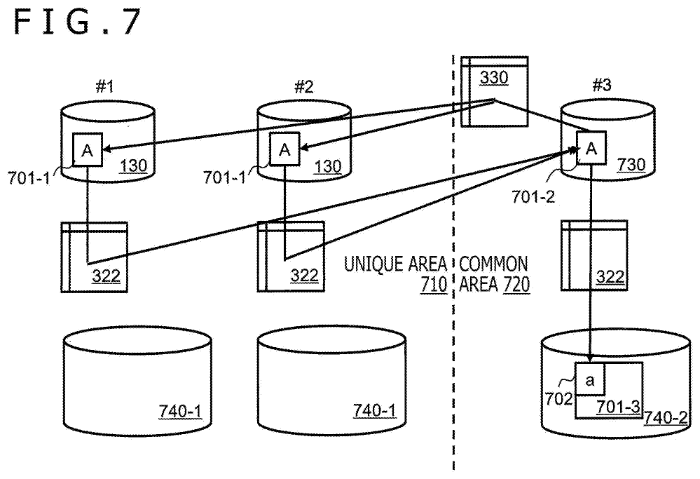

FIG. 7 is an explanatory diagram of an outline of data deduplication.

In the present embodiment, a unique area 710 that is a space where independent datasets that are datasets which are not duplicated with any dataset are stored, and a common area 720 that is a space where duplicated datasets that are datasets duplicated with any of the datasets are stored are prepared. In other words, logical address spaces in the storage system 201 are logically discriminated into the unique area 710 and the common area 720.

The storage controller 210 performs a duplication determination process for determining whether a target dataset in response to a write request to write data to the normal volume 130 is a dataset duplicated with one or more any datasets. The duplication determination process may be either a process (in-process) performed synchronously with a write request process or a process (post-process) performed after storage of the target dataset in response to the write request and asynchronously with the write request process.

In a case of determining that the target dataset is a dataset that is not duplicated with any dataset as a result of the duplication determination process, the storage controller 210 determines a storage destination of the dataset in the pool volume 440 as one page 461 belonging to the unique area 710. The page 461 belonging to the unique area 710 will be referred to as “unique page,” hereinafter.

In a case of determining that the target dataset is a duplicated dataset duplicated with one or more any datasets as a result of the duplication determination process, the storage controller 210 determines the storage destination of the duplicated dataset in the pool volume 440 as one page 461 belonging to the common area 720.

The page 461 is referred to by a plurality of write destinations of the duplicated datasets either directly or indirectly. The page 461 belonging to the common area 720 will be referred to as “common page,” hereinafter.

In a case in which the duplication determination process is the post-process, the storage controller 210 copies a dataset from each of a plurality of unique pages to the common page and deletes the dataset from each of the plurality of unique pages.

It is thereby possible to avoid occurrence of a situation in which an independent dataset and a duplicated dataset are mixed in one page 461, and promptly perform collection of the page 461 and copy of the dataset among the pages 461 in respect to the unique page.

In the following description, the address translation table 322 corresponding to a logical volume #m (logical volume having “m” as VOL #, where m is an integer equal to or greater than 0) will be referred to as “address translation table #m,” hereinafter. In addition, in the following description, an additional write volume corresponding to the logical volume #m will be referred to as “additional write volume #m.” Furthermore, in the following description, the following terms are often used.

Normal block: a normal block is a block 701-1 in the normal volume 130. The normal volume 130 is a logical volume distributed to the server system 202 and is, for example, CVDEV 510 (CDP volume 420).

It is noted that the logical volume is configured with a plurality of blocks that are a plurality of unit areas. In the present embodiment, a dataset is data per block.

Common block: a common block is a block 701-2 in the common volume 730. The common volume 730 is a logical volume belonging to the common area 720 and is, for example, the CVDEV 530 (CDP data volume 430).

Additional write block: an additional write block is a block 701-3 in an additional write volume 740. A compressed dataset is additionally written to the additional write block. An area occupied by the compressed dataset in the additional write block will be referred to as “sub-block” (sub-block 702). The additional write volume 740 is, for example, the LSCVDEV 540 (CDP data volume 430).

Additional write unique page: an additional write unique page is a page 461 that is a unique page and an additional write page. A compressed dataset is additionally written to and stored in the page 461. The page 461 allocated to the additional write volume 740 (page 461 indirectly allocated to the normal volume 130) will be referred to as “additional write page.”

Additional write common page: an additional write common page is a page 461 that is a common page and is an additional write page (page 461 allocated to the additional write volume 740 corresponding to the common volume 730).

As depicted in FIG. 7, in the duplication management table 330 after deduplication, reference sources of the logical address of the common block that is a write destination (copy destination) of the duplicated dataset are logical addresses of the two normal blocks that are copy sources.

Examples of the tables will be described hereinafter.

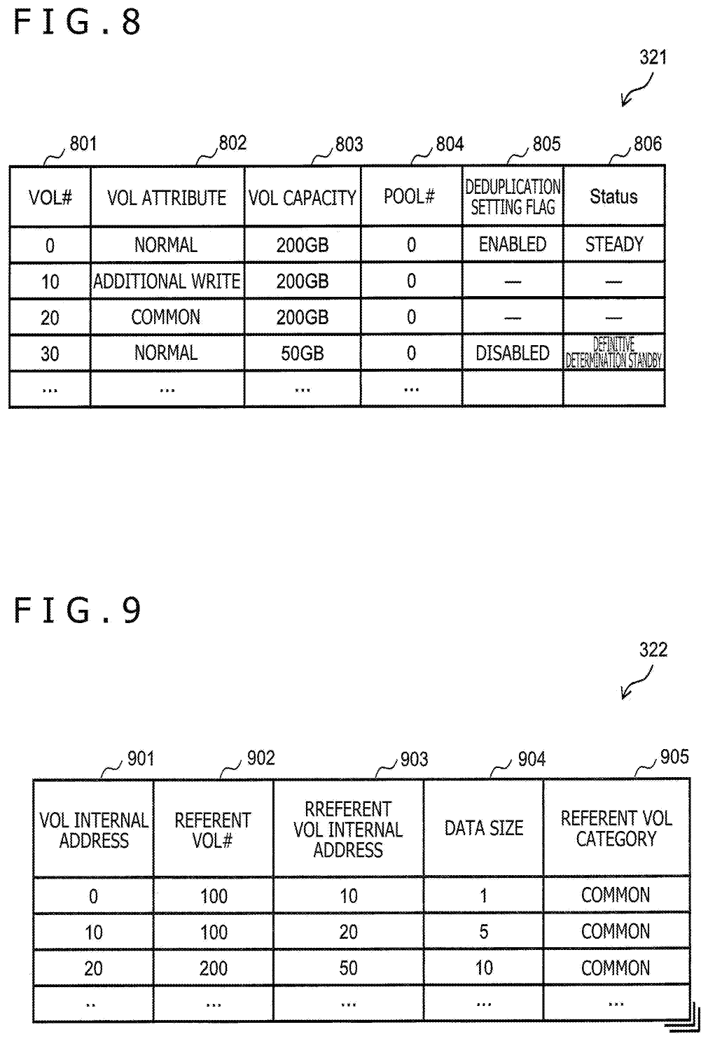

FIG. 8 depicts an example of the VOL management table 321. In the present embodiment, the logical volume such as the normal volume 130 distributed to the server system 202 and the logical volume such as the common volume 730 and the additional write volume 740 not distributed to the server system 202 may be generically referred to as “VOL.”

The VOL management table 321 holds information associated with VOLs. The VOL management table 321 has, for example, an entry per VOL. Each entry stores information such as a VOL #801, a VOL attribute 802, a VOL capacity 803, a pool #804, a deduplication setting flag 805, and a Status 806. The VOL management table 321 will be described while taking one VOL (referred to as “target VOL”) by way of example.

The VOL #801 is information about a number (identification number) of the target VOL. The VOL attribute 802 is information about an attribute of the target VOL. For example, the attribute of the normal volume 130 such as the CDP volume 420 (CVDEV 510) distributed to the server system 202 is “normal,” that of the additional write volume 740 such as the LSCVDEV 540 subjected to additional write is “additional write,” and that of the common volume 730 such as the CVDEV 530 in the common area 720 is “common.”

The VOL capacity 803 is information about a capacity of the target VOL. The pool #804 is information about a number of the pool volume 440 associated with the target VOL. The deduplication setting flag 805 is information as to whether to make deduplication about the target VOL enabled or disabled. The Status 806 is information indicating a state of the target VOL. For example, the steady state 610 is denoted by “steady,” the restore transient state 620 is denoted by “restore transient,” the definitive determination standby state 630 is denoted by “definitive determination standby,” the definitive determination transient state 640 is denoted by “definitive determination transient,” and the Undo transient state 650 is denoted by “Undo transient.”

FIG. 9 depicts an example of the address translation table 322. The address translation table 322 is set per VOL. The address translation table 322 holds information associated with a relationship between a logical address of a reference source and a logical address of a referent.

The address translation table 322 has, for example, an entry per block 701. Each entry stores a VOL internal address 901, a referent VOL #902, a referent VOL internal address 903, a data size 904, and a referent VOL category 905. The address translation table 322 will be described while taking one block 701 (referred to as “target block”) by way of example.

The VOL internal address 901 is a logical address of a target block (for example, top logical address) in the VOL. The referent VOL #902 is information about a number of a target block referent VOL. The referent VOL internal address 903 is information about a logical address corresponding to the logical address of the target block in the target block referent VOL (logical address within the referent VOL). The data size 904 is information about a size of a compressed dataset of a dataset to be written to the target block.

The referent VOL category 905 is information about a category of the target block referent VOL (category as to whether the referent VOL is a VOL in the unique area 710 or a VOL in the common area 720). It is noted that “unique” is not set to the referent VOL category 905 in the present embodiment since all the data is stored in the common volume 730.

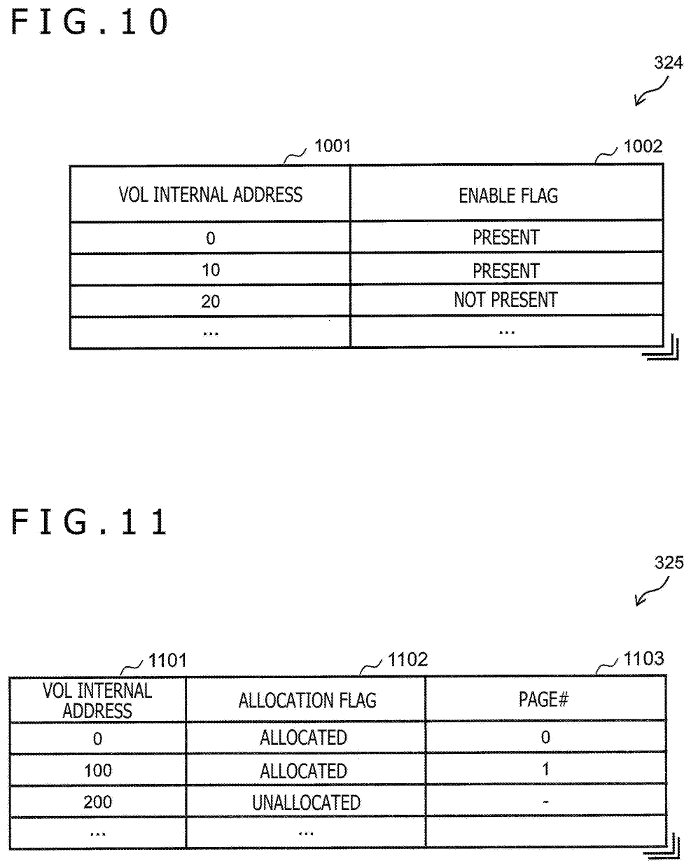

FIG. 10 depicts an example of the enabled area management table 324. The enabled area management table 324 is set per VOL. The enabled area management table 324 holds information associated with an enabled area. The enabled area management table 324 has, for example, an entry per block 701.

Each entry stores information such as a VOL internal address 1001 and an enable flag 1002. The enabled area management table 324 will be described while taking one block 701 (referred to as “target block”) by way of example.

The VOL internal address 1001 is information about the logical address of the target block. The enable flag 1002 is information indicating whether the target block belongs to an enabled area (“enabled”) or not (“disabled”).

FIG. 11 depicts an example of the page translation table 325. The page translation table 325 is set per VOL. The page translation table 325 holds information associated with a relationship between an area in a VOL (for example, blocks 701 corresponding to the size of one page 461) and the page 461.

The page translation table 325 has, for example, an entry per area in the VOL. Each entry stores information such as a VOL internal address 1101, an allocation flag 1102, and a page #1103. The page translation table 325 will be described while taking one area (referred to as “target area”) by way of example.

The VOL internal address 1101 is information about a logical address of the target area (for example, top logical address). The allocation flag 1102 is information as to whether a page 461 is allocated to the target area (“allocated”) or not (“unallocated”). The page #1103 is information about the number of the page 461 allocated to the target area.

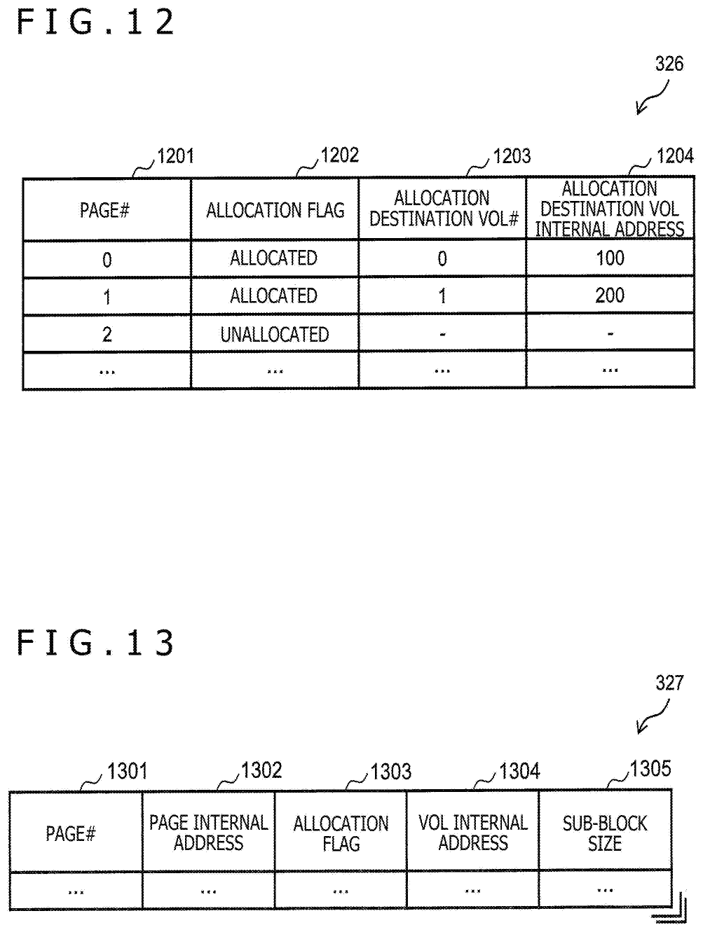

FIG. 12 depicts an example of the page allocation management table 326. The page allocation management table 326 is set per pool volume 440. The page allocation management table 326 holds information associated with a relationship between each page 461 and an allocation destination of the page 461. The page allocation management table 326 has, for example, an entry per page 461.

Each entry stores information such as a page #1201, an allocation flag 1202, an allocation destination VOL #1203, and an allocation destination VOL internal address 1204. The page allocation management table 326 will be described while taking one page 461 (referred to as “target page”) by way of example.

The page #1201 is information about a number of the target page. The allocation flag 1202 is information as to whether the target page is allocated (“allocated”) or not (“unallocated”). The allocation destination VOL #1203 is information about a number of a target page allocation destination VOL. The allocation destination VOL internal address 1204 is information about a logical address of an area (for example, top logical address) of an area in the target page allocation destination VOL.

FIG. 13 depicts an example of the sub-block management table 327. The sub-block management table 327 is set per additional write volume 740. The sub-block management table 327 holds information about sub-blocks 702. The sub-block management table 327 has, for example, an entry per sub-block 702.

Each entry stores information such as a page #1301, a page internal address 1302, an allocation flag 1303, a VOL internal address 1304, and a sub-block size 1305. The sub-block management table 327 will be described while taking one sub-block 702 (referred to as “target sub-block”) by way of example.

The page #1301 is information about a number of a page 461 containing the target sub-block. The page internal address 1302 is information about a logical address of the target sub-block in the page 461. The allocation flag 1303 is information as to whether the target sub-block is allocated (“allocated”) or not (“unallocated”), that is, whether the target sub-block is in use or not in use.

The VOL internal address 1304 is information about a logical address of a target sub-block allocation destination (logical address of an area in the additional write volume 740). The sub-block size 1305 is information about a size of the target sub-block (size of a compressed dataset stored in the target sub-block). It is noted that the page internal address 1302 may be identical to the VOL internal address 1304.

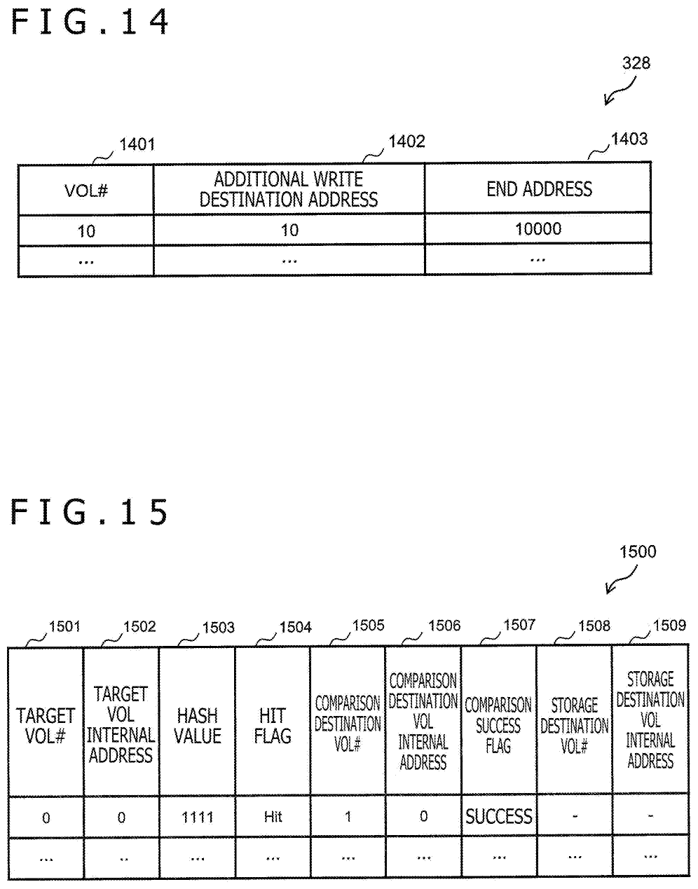

FIG. 14 depicts an example of the additional write destination search table 328. The additional write destination search table 328 holds information about a compressed dataset additional write destination. The additional write destination search table 328 has, for example, an entry per additional write volume 740. Each entry stores information such as a VOL #1401, an additional write destination address 1402, and an end address 1403.

The additional write destination search table 328 will be described while taking one additional write volume 740 (referred to as “target additional write volume 740”) by way of example.

The VOL #1401 is information about a number of the target additional write volume. The additional write destination address 1402 is information about a logical address of an additional write destination in the target additional write volume (logical address of the additional write destination in the additional write page allocated to the target additional write volume).

Here, the additional write destination address 1402 is information about a top logical address of the additional write destination. The end address 1403 is information about a logical address of an end of the logical address that can be an additional write destination. In a case in which a size according to a difference between the logical address of the additional write destination and the logical address of the end is smaller than a data size of the compressed data, the data is prohibited from being additionally written; thus, a top logical address of the target additional write volume may be set again as the additional write destination through a garbage collection process.

For example, the storage controller 210 may preferentially perform a garbage collection process on the additional write page closer to the top logical address of the target additional write volume. Allocation of the additional write pages is thereby released preferentially from the additional write page closer to the top logical address of the target additional write volume, and an area closer to the top logical address of the target additional write volume may be set as an unused area.

FIG. 15 depicts an example of the duplication check table 1500. The duplication check table 1500 is created and used in the duplication determination process. The duplication check table 1500 is created for data subjected to the duplication determination process and stored, for example, in the memory 212. The “data” mentioned herein is data to be subjected to a predetermined process and larger in size than a block. The duplication check table 1500 is stored, for example, in the local memory 301.

Owing to this, while the duplication determination process (and storage of data in either the unique area 710 or the common area 720) may be performed per block (per dataset), the duplication determination process (and storage of data in either the unique area 710 or the common area 720) is performed not per block but collectively per data to be subjected to the process in the present embodiment.

For example, the data to be subjected to the process is data in response to a write request to any of the normal volumes 130, the size of the data in response to the write request may be an integer multiple of a block size, and the duplication determination process (and storage of data in either the unique area 710 or the common area 720) may be performed per data in response to the write request (that is, per I/O request).

In this way, the duplication determination process (and storage of data in either the unique area 710 or the common area 720) is collectively performed per data to be subjected to the process, so that process efficiency is high. The duplication check table 1500 has, for example, an entry per block 701 out of one or more blocks 701 corresponding to each of one or more datasets configuring the data.

Each entry stores information such as a target VOL #1501, a target VOL internal address 1502, a hash value 1503, a hit flag 1504, a comparison destination VOL #1505, a comparison destination VOL internal address 1506, a comparison success flag 1507, a storage destination VOL #1508, and a storage destination VOL internal address 1509.

The duplication check table 1500 will be described while taking one block 701 (referred to as “target block”) by way of example.

The target VOL #1501 is information about a number of a VOL containing the target block. The target VOL internal address 1502 is information about a logical address of the target block. The hash value 1503 is information about a hash value corresponding to the target block (hash value of a dataset to be written to the target block). The hit flag 1504 is information as to whether there is a hit of a hash value (“Hit”) or there is no hit of a hash value (“Miss”). “Hit of the hash value” means that a hash value that matches the hash value corresponding to the target block is already present.

The comparison destination VOL #1505 is enabled in a case in which there is a hit of a hash value for the target block and is information about a number of a comparison destination VOL. The “comparison destination VOL” is a VOL that stores a dataset having the hash value matching the hash value corresponding to the target block, and is a VOL as a dataset comparison destination.

The comparison destination VOL internal address 1506 is information about a logical address of the block 701 that stores the dataset having the hash value matching the hash value corresponding to the target block (logical address of the block 701 in the comparison destination VOL). A plurality of sets of the comparison destination VOL #1505 and the comparison destination VOL internal address 1506 may be present for the target block.

The comparison success flag 1507 is information as to whether comparison of datasets performed in the case in which there is a hit of a hash value for the target block succeeds (“success”) or fails (“failure”). In a case in which the datasets match each other, the comparison success flag 1507 indicates “success.”

The storage destination VOL #1508 is information about a number of a storage destination VOL. The “storage destination VOL” is a VOL as a storage destination of the dataset to be written to the target block.

The storage destination VOL internal address 1509 is information about a logical address of the block 701 in the storage destination of the dataset to be written to the target block (logical address of the block 701 in the storage destination VOL).

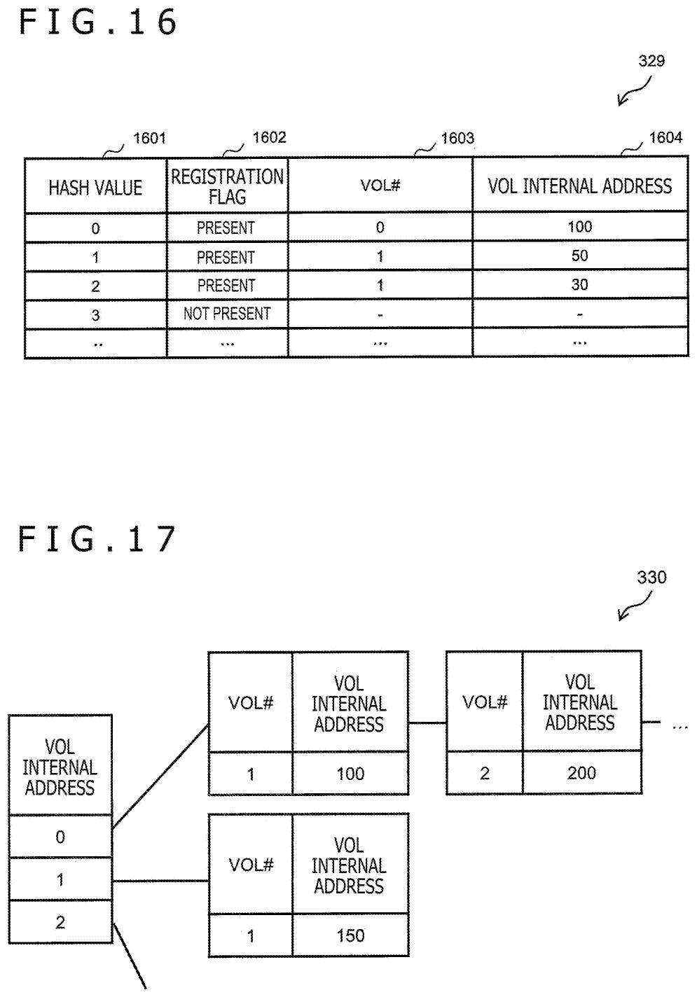

FIG. 16 depicts an example of the hash management table 329. The hash management table 329 holds information associated with a hash value of each dataset. The hash management table 329 has, for example, an entry per hash value.

Each entry stores information such as a hash value 1601, a registration flag 1602, a VOL #1603, and a VOL internal address 1604. The has management table 329 will be described while taking one hash value (referred to as “target hash value”) by way of example.

The hash value 1601 is information about the target hash value itself. The registration flag 1602 is information as to whether a dataset having the target hash value as a hash value is present in the storage system 201 (“present”) or not (“not present”).

The VOL #1603 is information about a number of a VOL storing the dataset having the target hash value as the hash value. The VOL internal address 1604 is information about a logical address of the block 701 that stores the dataset having the target hash value as the hash value.

In the duplication determination process, in the case in which there is a hit of a hash value for the target hash value, information about the VOL #1603 and the VOL internal address 1604 corresponding to the target hash value is used as the information about the comparison destination VOL #1505 and the comparison destination VOL internal address 1506 in the duplication check table 1500 depicted in FIG. 15.

FIG. 17 depicts an example of the duplication management table 330. The duplication management table 330 holds information associated with a position (logical address) of each duplicated dataset. The duplication management table 330 has, for example, per common block out of a plurality of common blocks configuring the common volume 730, a VOL internal address (logical address).

Each reference source entry is associated with a common block in which a reference source is present in, for example, a queue form. The reference source entry stores VOL # (number of a VOL containing a reference source block 701) and a VOL internal address (logical address of the reference source block 701).

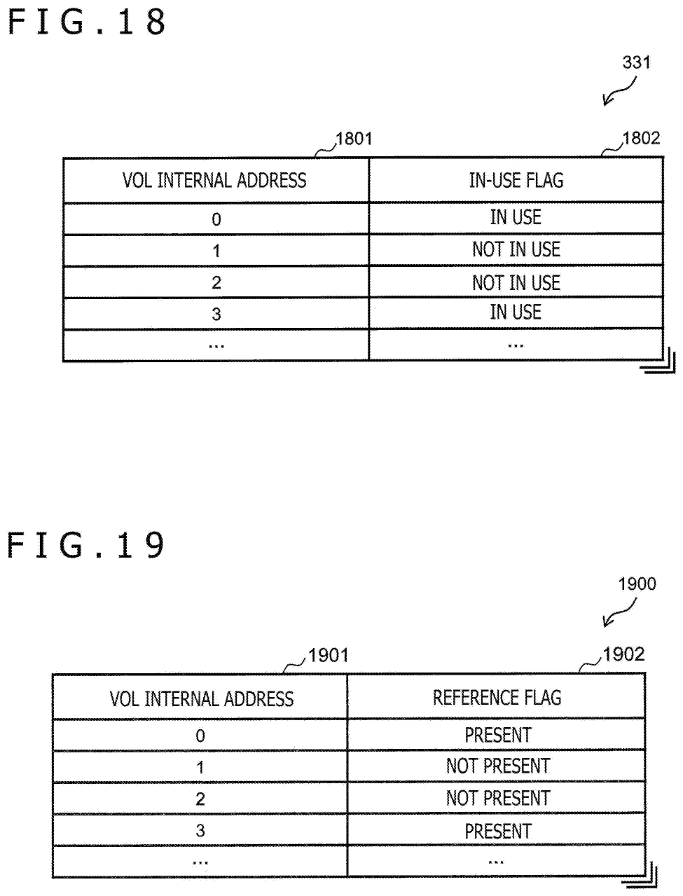

FIG. 18 depicts an example of the common area allocation management table 331. The common area allocation management table 331 is set per common volume 730. The common area allocation management table 331 holds information associated with a vacant situation of the common volume 730.

The common area allocation management table 331 has, for example, an entry per common block out of a plurality of common blocks configuring the common volume 730. Each entry stores information such as a VOL internal address 1801 and an in-use flag 1802. The common area allocation management table 331 will be described while taking one common block (referred to as “target block”) by way of example.

The VOL internal address 1801 is information about a logical address of the target block. The in-use flag 1802 is information as to whether the target block is in use (“in use”) or not in use “(not in use”).

In the case in which the in-use flag 1802 indicates the information of “in use,” this means that a page 461 is allocated to the target block either directly (not via the additional write volume 740) or indirectly (via the additional write volume 740). In the case in which the in-use flag 1802 indicates the information of “not in use,” this means that a page 461 is not allocated to the target block, that is, the target block is vacant.

FIG. 19 depicts an example of the common area check table 1900. The common area check table 1900 is set per common volume 730. The common area check table 1900 holds information associated with a situation of referring to the common volume 730. The common area check table 1900 is stored, for example, in the local memory 301.

The common area check table 1900 has, for example, an entry per common block out of the plurality of common blocks configuring the common volume 730. Each entry stores information such as a VOL internal address 1901 and a reference flag 1902. The common area check table 1900 will be described while taking one common block (referred to as “target block”) by way of example.

The VOL internal address 1901 is information about a logical address of the target block. The reference flag 1902 is information as to whether the block 701 that is one or more reference sources is present for the target block (“present”) or not (“not present”).

Processes performed in the present embodiment will be described hereinafter. In the following description, compression and decompression of a dataset may be executed by the data volume reduction program 314 (or by invoking the data volume reduction program 314).

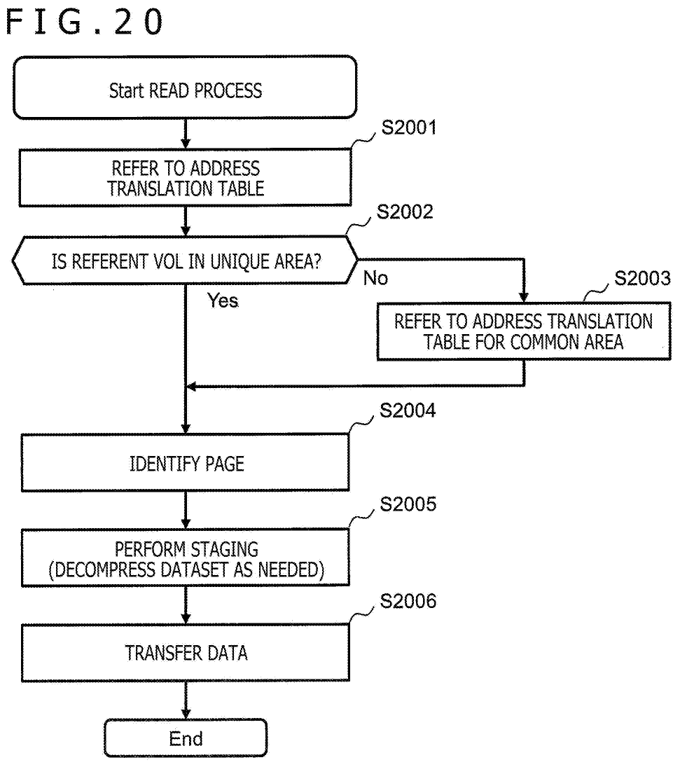

FIG. 20 depicts an example of a flow of a read process. The read process is performed in a case in which a read request to read a VOL (for example, the normal volume 130) is received.

The read program 311 refers to the address translation table 322 corresponding to the VOL for which the read request is issued (to-be-processed volume) (Step S2001).

The read program 311 identifies an entry (one or more blocks) corresponding to the logical address in the read request from the address translation table 322 corresponding to the to-be-processed volume on the basis of the address translation table 322, and determines whether the information about the referent VOL category 905 in the identified entry is “unique” (S2002).

It is noted that the process from Steps S2002 to S2005 is performed per block 701.

In a case in which a determination result of Step S2002 is False (Step S2002: NO), the read program 311 refers to the address translation table 322 for the common area (Step S2003). More specifically, the read program 311 refers to the address translation table 322 corresponding to the referent VOL (for example, CDP data volume 430) on the basis of the information about the referent VOL #902 in the entry identified in Step S2002.

In a case in which the determination result of Step S2002 is True (Step S2002: YES) or after Step S2003, the read program 311 identifies the page 461 on the basis of the page translation table 325 (Step S2004). More specifically, the read program 311 first identifies an entry corresponding to the referent VOL internal address 903 identified in Step S2002 from the address translation table 322, and refers to the page translation table 325 corresponding to the VOL (for example, LSCVDEV 540) of the referent VOL #902 in the identified entry. Next, the read program 311 identifies an entry corresponding to the referent VOL internal address 903 in the identified entry from the page translation table 325, and acquires information about the page #1103 in the identified entry.

Subsequently, the read program 311 reads a compressed dataset corresponding to the block 701 identified in Step S2002 from the identified page 461, decompresses the compressed dataset, and stores the decompressed dataset in the cache memory 302 (Step S2005).

When the process up to Step S2005 is over for the block 701 identified in Step S2002, the data in response to the read request is stored in the cache memory 302; thus, the read program 311 transfers the stored data to a read request issuance source (Step S2006) and ends the read process.

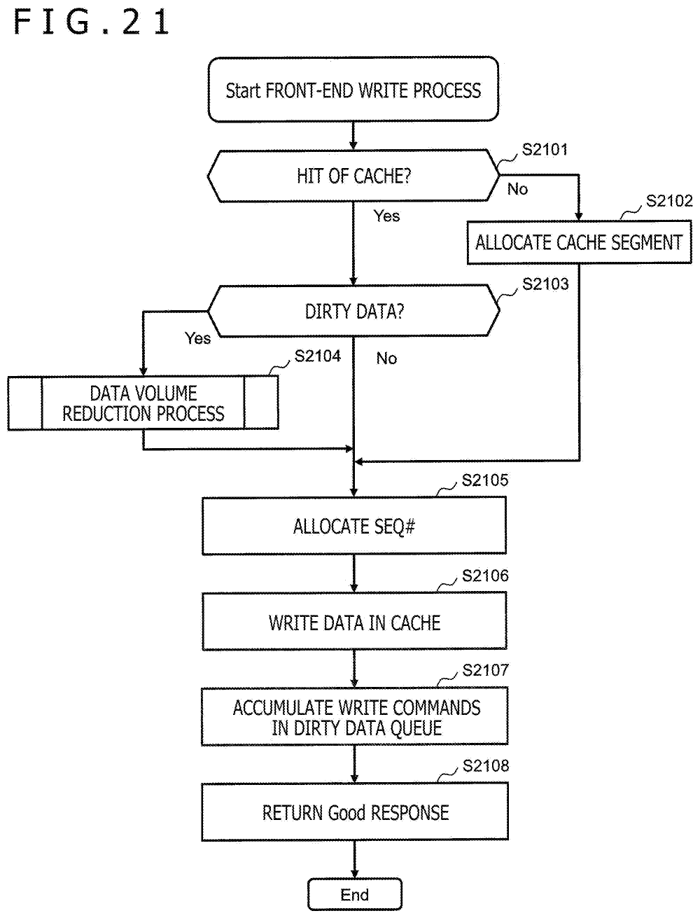

FIG. 21 depicts an example of a flow of a front-end write process. The front-end write process is performed in a case in which a write process for a VOL (for example, the normal volume 130) is received.

The front-end write program 312 determines whether there is a hit of a cache (Step S2101). As for the write request, the “hit of a cache” means that a cache segment (area in the cache memory 302) corresponding to a write destination in response to the write request is ensured.

In a case in which a determination result of Step S2101 is False (Step S2101: NO), the front-end write program 312 allocates a cache segment from the cache memory 302 (Step S2102).

In a case in which the determination result of Step S2101 is True (Step S2101: YES), the front-end write program 312 determines whether data in the cache segment is dirty data (Step S2103). The “dirty data” is data stored in the cache memory 302 and means data that is not stored in the PDEV 220.

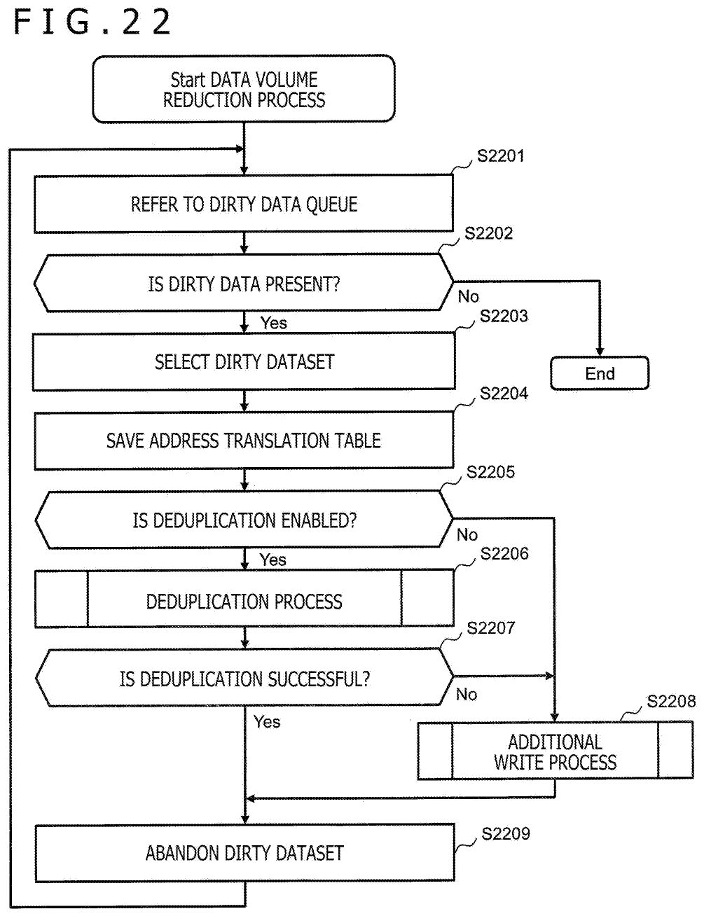

In a case in which a determination result of Step S2103 is True (Step S2103: YES), the front-end write program 312 performs a data volume reduction process (Step S2104). It is noted that the data volume reduction process will be described later with reference to FIG. 22.

In a case in which the determination result of Step S2103 is False (Step S2103: NO) or the process in Step S2102 or S2104 is performed, the front-end write program 312 allocates a SEQ # (Step S2105).

Subsequently, the front-end write program 312 writes to-be-written data in response to the write request to the allocated cache segment (Step S2106).

Subsequently, the front-end write program 312 adds the SEQ # allocated in Step S2105 to a dirty data queue, and accumulates write commands for one or more datasets configuring the to-be-written data in the dirty data queue (Step S2107).

The “dirty data queue” is a queue in which the write commands to dirty datasets (datasets that are not stored in the PDEV 220) are accumulated.

Subsequently, the front-end write program 312 returns a GOOD response (write completion response) to a write request issuance source (Step S2108). It is noted that the GOOD response to the write request may be returned in a case of completion of a back-end write process.

It is noted that the back-end write process may be performed either synchronously or asynchronously with the front-end write process. The back-end write process is performed by the back-end write program 313.

FIG. 22 depicts an example of a flow of the data volume reduction process. The data volume reduction process is performed in, for example, the front-end write process. It is noted that the data volume reduction process may be performed, for example, on regular basis.

The data volume reduction program 314 refers to the dirty data queue (Step S2201), determines whether a command is present in the dirty data queue (Step S2202), and ends the data volume reduction process in a case in which a determination result of Step S2202 is False (Step S2202: NO).

In a case in which the determination result of Step S2202 is True (Step S2202: YES), the data volume reduction program 314 acquires a write command from the dirty data queue, that is, selects a dataset of the dirty data (dirty dataset) (Step S2203).

Subsequently, the data volume reduction program 314 saves the address translation table 322 (Step S2204). More specifically, the data volume reduction program 314 sets the SEQ # held in the dirty data queue to the SEQ #401, and current time to the WR time 402. In addition, the data volume reduction program 314 acquires a VOL number and an LBA, and sets the VOL number and the LBA to the CDPVOL-LDEV #403 and the CDPVOL-LBA 404, respectively. Furthermore, the data volume reduction program 314 identifies an entry corresponding to the LBA in the write request from the address translation table 322 corresponding to the CDP data volume 420 for which the write request is issued, and acquires information about the referent VOL internal address 903 in the identified entry (old data) (position information in the CVDEV 530). The data volume reduction program 314 then sets the acquired position information in the CVDEV 530 to the CDPDATAVOL position information 405.

Subsequently, the data volume reduction program 314 refers to the VOL management table 321, and determines whether the deduplication setting flag 805 for the VOL for which the write request is issued is “enabled” (Step S2205).

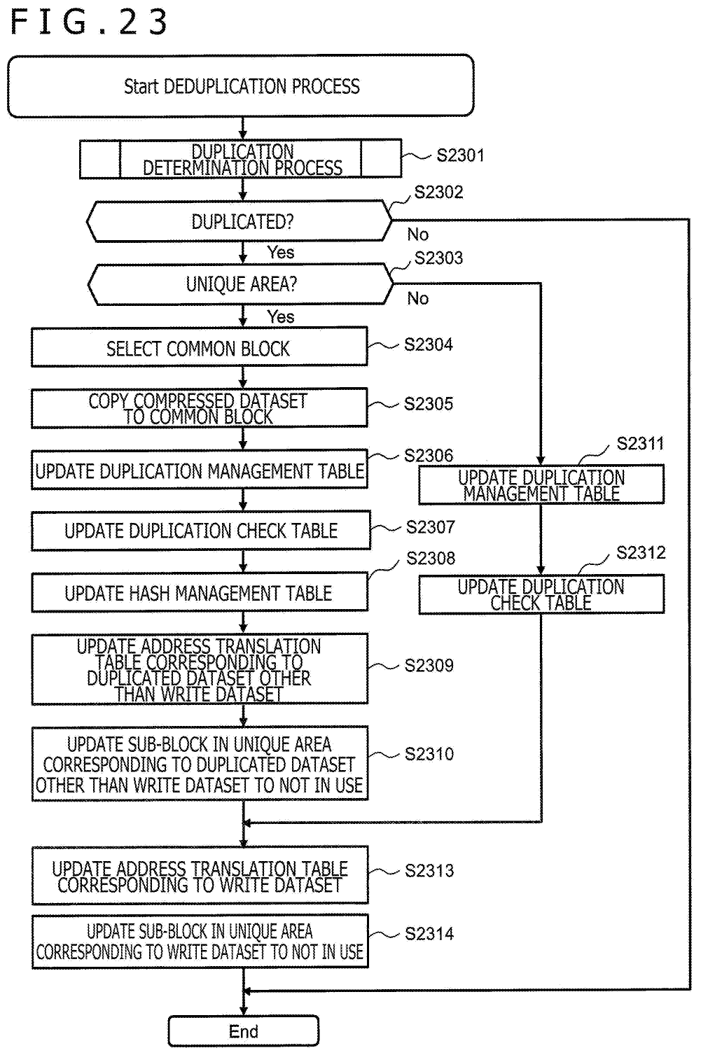

In a case in which a determination result of Step S2205 is True (Step S2205: YES), the data volume reduction program 314 performs the deduplication process for the dirty dataset selected in Step S2203 (Step S2206). It is noted that the deduplication process will be described later with reference to FIG. 23.

Subsequently, the data volume reduction program 314 determines whether deduplication is successful (Step S2207).

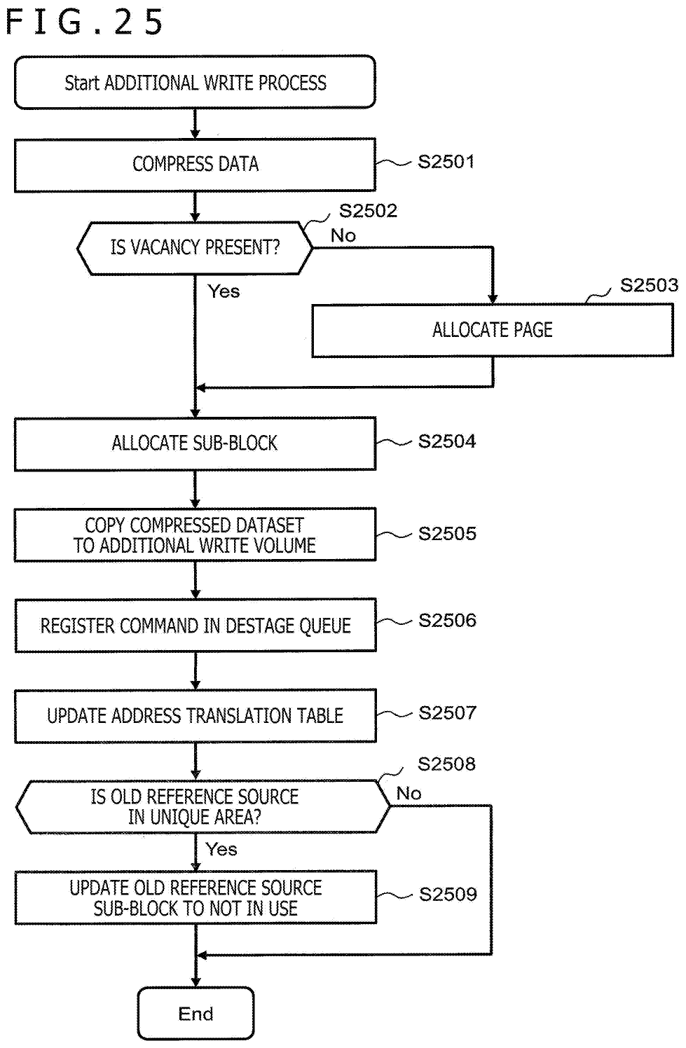

In a case in which the determination result of Step S2205 is False (Step S2205: NO) or a determination result of Step S2207 is False (Step S2205: NO), the data volume reduction program 314 performs an additional write process for the dirty dataset (Step S2208). It is noted that the additional write process will be described later with reference to FIG. 25.

In a case in which the determination result of Step S2207 is True (Step S2207: YES) or the additional write process is over, the data volume reduction program 314 abandons the dirty dataset selected in Step S2203 (for example, deletes the selected dirty dataset from the cache memory 302) (Step S2209), and returns the process to Step S2201.

FIG. 23 depicts an example of a flow of the deduplication process. The deduplication process is performed for the dirty dataset selected in Step S2203 of FIG. 22. In the following description with reference to FIGS. 23 to 25, the dirty dataset selected in Step S2203 will be referred to as “write dataset,” the block 701 as a write destination of the write dataset will be referred to as “write destination block,” and the VOL containing the write destination block will be referred to as “write destination volume.”

The data volume reduction program 314 performs the duplication determination process to be described later for the write dataset (Step S2301), determines whether the write dataset is duplicated (Step S2302), and ends the deduplication process in a case in which the write dataset is an independent dataset (unduplicated dataset) as a determination result of Step S2301 (Step S2302: NO).

In a case in which the write dataset is a duplicated dataset as the determination result of Step S2301 (Step S2302: YES), the data volume reduction program 314 determines whether another duplicated dataset duplicated with the write dataset is present in the unique area 710 (Step S2303).

It is noted that in the following description with reference to FIG. 23, each of the write dataset and another duplicated dataset duplicated with the write dataset will be generically referred to as “duplicated datasets.” In other words, in the following description with reference to FIG. 23, the “duplicated dataset” may be either any of the two or more datasets including the write dataset.

In a case in which the duplicated dataset is a dataset already present in the unique area 710, the data volume reduction program 314 may temporarily decompress a compressed dataset of the dataset present in the unique area 710 and assume the decompressed dataset as the duplicated dataset in any of Steps S2304 and S2305 to be described later.

Furthermore, determination of Step S2303 is carried out on the basis of, for example, whether information about the comparison destination VOL #1505 corresponding to the write destination block matches information about the VOL #801 with the VOL attribute 802 of “normal” or whether the information about the VOL attribute 802 matches the information about the VOL #801 of “common.”

In a case in which the information about the comparison destination VOL #1505 corresponding to the write destination block matches the information about the VOL #801 with the information about the VOL attribute 802 of “normal,” then another duplicated dataset is present in the unique area 710, and a determination result of Step S2303 is, therefore, True (YES).

In a case in which the information about the comparison destination VOL #1505 corresponding to the write destination block matches the information about the VOL #801 with the information about the VOL attribute 802 of “common,” then another duplicated dataset is present in the common area 720, and the determination result of Step S2303 is, therefore, False (NO).

In the case in which the determination result of Step S2303 described above is True (Step S2303: YES), the data volume reduction program 314 moves the process to Step S2304. In addition, the data volume reduction program 314 selects a common block with information about the in-use flag 1802 of “not in use” (Step S2304).

The common block selected in Step S2304 will be referred to as “target common block” and a VOL containing the target common block will be referred to as “target common volume,” hereinafter.

The data volume reduction program 314 compresses the duplicated dataset, and additionally writes the compressed dataset to the additional write common page (common page allocated to the additional write volume 740 corresponding to the target common volume, particularly target common block) (Step S2305).

The data volume reduction program 314 updates the duplication management table 330 (Step S2306). More specifically, the data volume reduction program 314 associates one or more blocks 701 corresponding to one or more duplicated datasets with the target common block as reference sources.

The data volume reduction program 314 updates the duplication check table 1500 (Step S2307). More specifically, the data volume reduction program 314 registers the number of the target common volume and the logical address of the target common block as the information about the storage destination VOL #1508 and the information about the storage destination VOL internal address 1509 corresponding to the write destination block, respectively.

The data volume reduction program 314 updates the hash management table 329 (Step S2308). For example, the data volume reduction program 314 registers information about the hash value 1601 (hash value of the duplicated dataset), the registration flag 1602 (“present”), the VOL #1603 (number of the target common volume), and the VOL internal address 1604 (logical address of the target common block).

The data volume reduction program 314 updates the address translation table 322 corresponding to the normal volume 130 that stores the duplicated dataset other than the write dataset (Step S2309).

As a result of this update of the address translation table 322, the information about the referent VOL #902 and the information about the referent VOL internal address 903 corresponding to the duplicated dataset are changed to the number of the target common volume and the logical address of the target common block, respectively, and the information about the referent VOL category 905 corresponding to the duplicated dataset is changed to “common.”

The data volume reduction program 314 updates the sub-block management table 327 associated with the additional write volume 740 corresponding to the normal volume 130 that stores the duplicated dataset other than the write dataset (Step S2310). More specifically, the data volume reduction program 314 changes the information about the allocation flag 1303 corresponding to the sub-block 702 that stores the compressed dataset of the duplicated dataset other than the write dataset to “unallocated.”

In a case in which the determination result of Step S2303 is False (Step S2303: NO), the data volume reduction program 314 moves the process to Step S2311. The data volume reduction program 314 then updates the duplication management table 330 (Step S2311). More specifically, the data volume reduction program 314 associates the write destination block with the common block that stores the duplicated dataset as a new reference source.

The data volume reduction program 314 updates the duplication check table 1500 (Step S2312). More specifically, the data volume reduction program 314 registers the logical address of the common block that stores the duplicated dataset and the number of the common volume 730 containing the common block storing the duplicated dataset as the information about the storage destination VOL internal address 1509 and the information about the storage destination VOL #1508 corresponding to the write destination block, respectively.

After Step S2310 or S2312, the data volume reduction program 314 updates the address translation table 322 corresponding to the write destination volume (Step S2313).

As a result of this update of the address translation table 322, the information about the referent VOL #902 and the information about the referent VOL internal address 903 corresponding to the write destination block (write dataset) are changed to the number of the common volume 730 and the logical address of the common block, respectively, and the information about the referent VOL category 905 corresponding to the write destination block is changed to “common.”

In a case in which the compressed dataset of the write dataset is present in the additional write page, the data volume reduction program 314 updates the sub-block management table 327 associated with the additional write volume 740 corresponding to the write destination volume (Step S2314). More specifically, the data volume reduction program 314 changes the allocation flag 1303 corresponding to the sub-block 702 that stores the compressed dataset of the write dataset to “unallocated.”

While the deduplication process is a process as the post-process described above in the present embodiment, Step S2314 of FIG. 23, for example, may be omitted in a case in which the deduplication process is a process as the in-process. This is because the deduplication is performed without additionally writing the compressed dataset of the write dataset (or without compressing the write dataset).

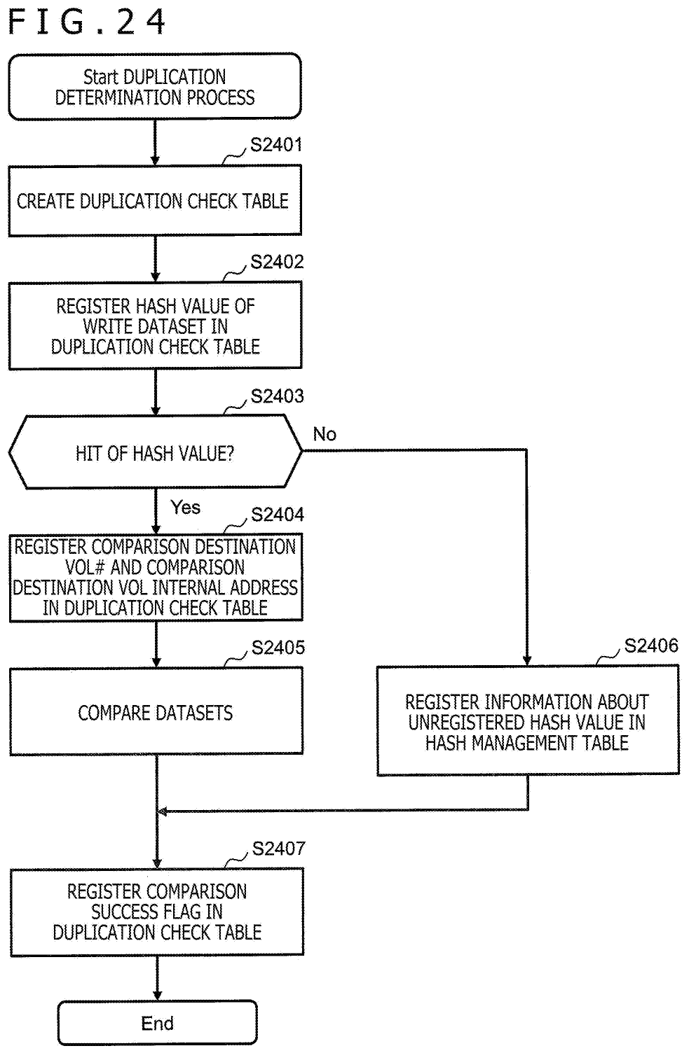

FIG. 24 depicts an example of a flow of the duplication determination process.

The data volume reduction program 314 creates the duplication check table 1500 in relation to the write dataset (Step S2401).

In a case, for example, in which the deduplication process is performed in units of data subjected to a predetermined process such as in I/O units and data eventually contains a plurality of datasets, the duplication check table 1500 has a plurality of entries corresponding to the plurality of datasets.

The data volume reduction program 314 registers a hash value of the write dataset as the information about the hash value 1503 corresponding to the write destination block (Step S2402).

The data volume reduction program 314 determines whether the hash value matching the hash value registered in Step S2402 is registered in the hash management table 329, that is, whether there is a hit of a hash value (Step S2403).

In a case in which a determination result of Step S2403 is True (Step S2403: YES), the data volume reduction program 314 updates the duplication check table 1500 (Step S2404). More specifically, the data volume reduction program 314 registers the information about the VOL #1603 and the information about the VOL internal address 1604 corresponding to the hash value matching the hash value registered in Step S2402, as the information about the comparison destination VOL #1505 and the comparison destination VOL internal address 1506 corresponding to the write destination block, respectively.

The data volume reduction program 314 compares the write dataset with a dataset (for example, decompressed dataset) acquired on the basis of the information about the comparison destination VOL #1505 and the comparison destination VOL internal address 1506 (Step S2405). This comparison of Step S2405 may be comparison of compressed datasets.

In a case in which the determination result of Step S2403 is False (Step S2403: NO), the data volume reduction program 314 updates the hash management table 329 (Step S2406). More specifically, the data volume reduction program 314 registers information about the hash value 1601 (hash value of the write dataset), the registration flag 1602 (“present”), the VOL #1603 (number of write destination volume), and the VOL internal address 1604 (logical address of the write destination block) in a new entry.

After Step S2405 or S2406, the data volume reduction program 314 updates the duplication check table 1500 (Step S2407). More specifically, the data volume reduction program 314 registers information about the comparison success flag 1507 corresponding to the write destination block.

In this registration, in a case, for example, in which the datasets match each other as a result of the comparison of the datasets in Step S2405, “success” is registered as the information about the comparison success flag 1507. In a case in which the datasets do not match each other as a result of the comparison of the datasets in Step S2405 or in a case in which Step S2406 is executed, “failure” is registered as the information about the comparison success flag 1507.

FIG. 25 depicts an example of a flow of the additional write process. The additional write process is performed for the dirty dataset selected in Step S2203 of FIG. 22.

The data volume reduction program 314 compresses the write dataset and stores the compressed dataset in, for example, the local memory 301 (Step S2501).

The data volume reduction program 314 determines whether a vacancy equal to or greater than a size of the compressed dataset is present in the page 461 already allocated to the additional write volume 740 corresponding to the write destination volume (Step S2502).

To perform this determination, the data volume reduction program 314 may identify the logical address registered as the information about the additional write destination address 1402 corresponding to the additional write volume 740, and refer to the sub-block management table 327 corresponding to the additional write volume 740 using the number of the page 461 allocated to the area to which the identified logical address belongs as a key.

In a case in which a determination result of Step S2502 is False (Step S2502: NO), the data volume reduction program 314 allocates an unallocated page 461 to the additional write volume 740 corresponding to the write destination volume (Step S2503).

In a case in which the determination result of Step S2502 is True (Step S2502: YES) or after the process is performed in Step S2503, the data volume reduction program 314 allocates the sub-block 702 as an additional write destination (Step S2504).

The data volume reduction program 314 copies the compressed dataset of the write dataset to the additional write volume 740, for example, copies the compressed dataset to an area for the additional write volume 740 (area in the cache memory 302) (Step S2505).

The data volume reduction program 314 registers a write command to the compressed dataset in a destage queue (Step S2506), and updates the address translation table 322 corresponding to the write destination volume (Step S2507).

As a result of this update of the address translation table 322, the information about the referent VOL #902 and the information about the referent VOL internal address 903 corresponding to the write destination block are changed to the number of the additional write volume 740 and the logical address of the sub-block 702 allocated in Step S2504, respectively, and the information about the referent VOL category 905 corresponding to the write destination block is changed to “unique.”

The data volume reduction program 314 determines whether a reference source of an old sub-block (old reference source) is the logical address of the write destination block (that is, the old reference source is in the unique area 710) (Step S2508). The “old sub-block” is the sub-block 702 that stores the compressed dataset before update of the compressed dataset of the write dataset.

In a case in which a determination result of Step S2508 is True (Step S2508: YES), the data volume reduction program 314 updates the information about the allocation flag 1303 corresponding to the old sub-block to “unallocated” (Step S2509).

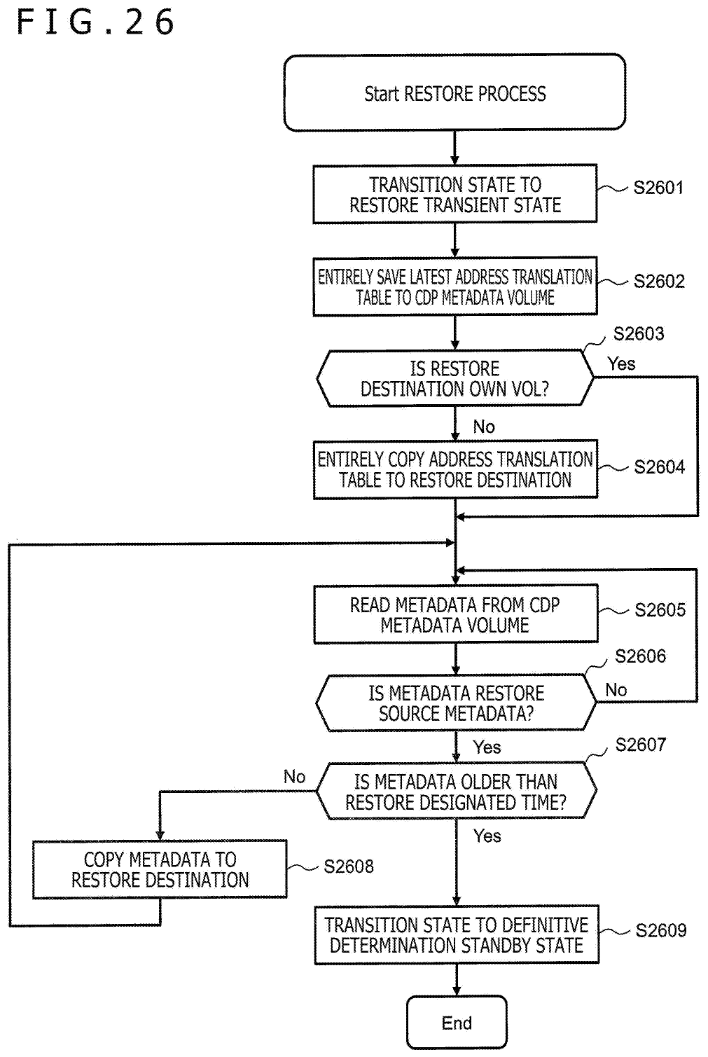

FIG. 26 depicts an example of a flow of the restore process. The restore process is performed on the basis of the restore operation from the management system 203. The CDP volume 420 for which the restore operation is issued will be referred to as “restore target VOL.”

The CDP control program 318 transitions the state of the restore target VOL to the restore transient state (Step S2601). More specifically, the CDP control program 318 sets the Status 806 of the restore target VOL to “restore transient.”

Subsequently, the CDP control program 318 entirely saves the address translation table 322 (latest address translation table 322) corresponding to the CDP volume 420 at a point in time of the restore operation to the CDP metadata volume 450 (Step S2602). By saving the latest address translation table 322, the CDP control program 318 can return the restore target VOL into an original state even after restore at an arbitrary point in time.

Subsequently, the CDP control program 318 determines whether a restore destination VOL is the own VOL (restore target VOL) (Step S2603).

In a case in which a determination result of Step S2603 is False (Step S2603: NO), the CDP control program 318 entirely copies the address translation table 322 corresponding to the restore target VOL to the restore destination VOL (Step S2604). It is thereby possible to construct (reproduce) the own VOL in the restore destination VOL.

In a case in which the determination result of Step S2603 is True (Step S2603: YES), the CDP control program 318 moves the process to Step S2605.

In Step S2605, the CDP control program 318 reads the latest metadata 400 among unprocessed metadata 400 (journal data) from the CDP metadata volume 450. The metadata 400 read in Step S2605 will be referred to as “to-be-processed metadata,” hereinafter.

The CDP control program 318 determines whether the to-be-processed metadata is the metadata 400 about the restore target VOL (restore source) on the basis of the CDPVOL-LDEV #403 of the to-be-processed metadata (Step S2606).

In a case in which a determination result of Step S2606 is False (Step S2606: NO), the CDP control program 318 returns the process to Step S2605.

In a case in which the determination result of Step S2606 is True (Step S2606: YES), the CDP control program 318 determines whether the to-be-processed metadata is metadata 400 older than the restore designated time on the basis of the WR time 402 of the to-be-processed metadata (Step S2607).

In a case in which a determination result of Step S2607 is False (Step S2607: NO), the CDP control program 318 copies the to-be-processed metadata to the restore destination VOL (Step S2608) and returns the process to Step S2605. At a time of this copy, the CDP control program 318 identifies an entry having the VOL internal address 901 to be rewritten in the address translation table 322 from the CDPVOL-LBA 404 of the to-be-processed metadata (position information of the to-be-processed metadata in the CVDEV 510), and updates the referent VOL #902 and the referent VOL internal address 903 in the identified entry on the basis of the CDPDATAVOL position information 405 (position information in the CVDEV 530).

In a case in which the determination result of Step S2607 is True (Step S2607: YES), the CDP control program 318 transitions the state of the restore target VOL to the definitive determination standby state (Step S2609). More specifically, the CDP control program 318 sets the Status 806 of the restore target VOL to “definitive determination standby.”

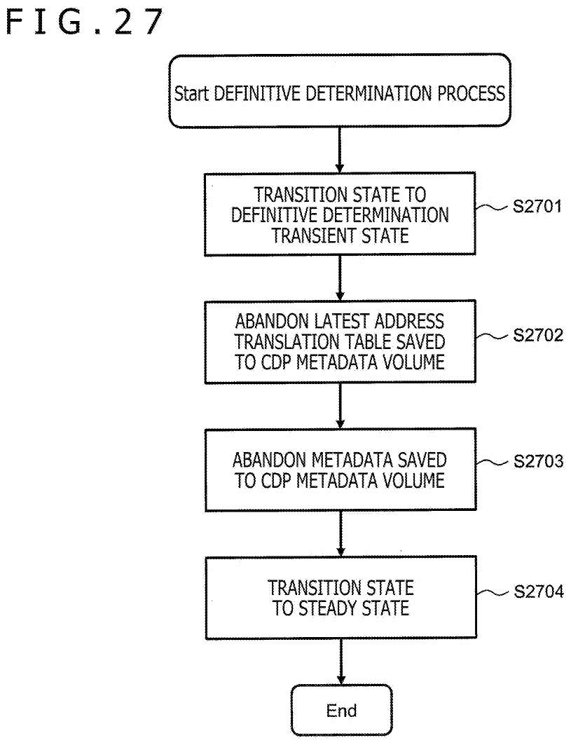

FIG. 27 depicts an example of a flow of the definitive determination process. The definitive determination process is performed on the basis of the restore definitive determination operation from the management system 203.

The CDP control program 318 transitions the state of the restore target VOL to the definitive determination transient state (Step S2701). More specifically, the CDP control program 318 sets the Status 806 of the restore target VOL to “definitive determination transient.”

Subsequently, the CDP control program 318 abandons the latest address translation table 322 saved to the CDP metadata volume 450 (Step S2702).

Subsequently, the CDP control program 318 abandons the metadata 400 saved to the CDP metadata volume 450 (Step S2703). The CDP control program 318 abandons, for example, the metadata 400 that is about the restore target VOL and that is more recent metadata 400 than the restore designated time.

Subsequently, the CDP control program 318 transitions the state of the restore target VOL to the steady state (Step S2704). More specifically, the CDP control program 318 sets the Status 806 of the restore target VOL to “steady.”

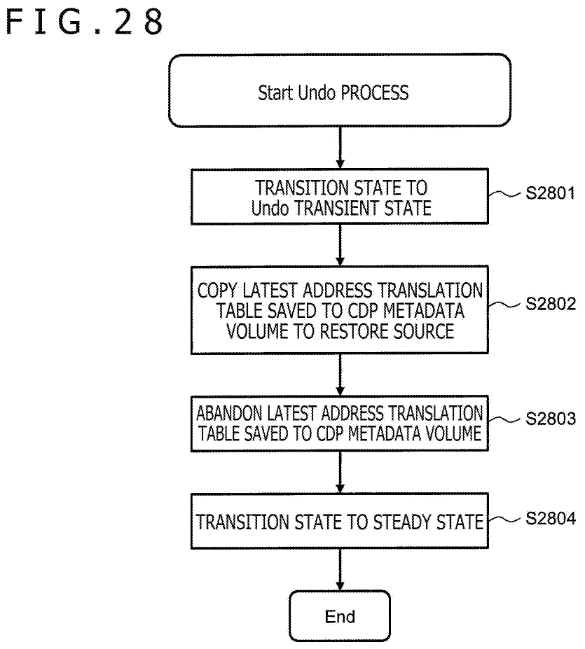

FIG. 28 depicts an example of a flow of the Undo process. The Undo process is performed on the basis of a restore Undo operation from the management system 203.

The CDP control program 318 transitions the state of the restore target VOL to the Undo transient state (Step S2801). More specifically, the CDP control program 318 sets the Status 806 of the restore target VOL to “Undo transient.”

Subsequently, the CDP control program 318 copies the latest address translation table 322 saved to the CDP metadata volume 450 to the restore target VOL (restore source) (Step S2802).

Subsequently, the CDP control program 318 abandons the latest address translation table 322 saved to the CDP metadata volume 450 (Step S2803).

Subsequently, the CDP control program 318 transitions the state of the CDP volume 420 to the steady state (Step S2804). More specifically, the CDP control program 318 sets the Status 806 of the restore target VOL to “steady.”

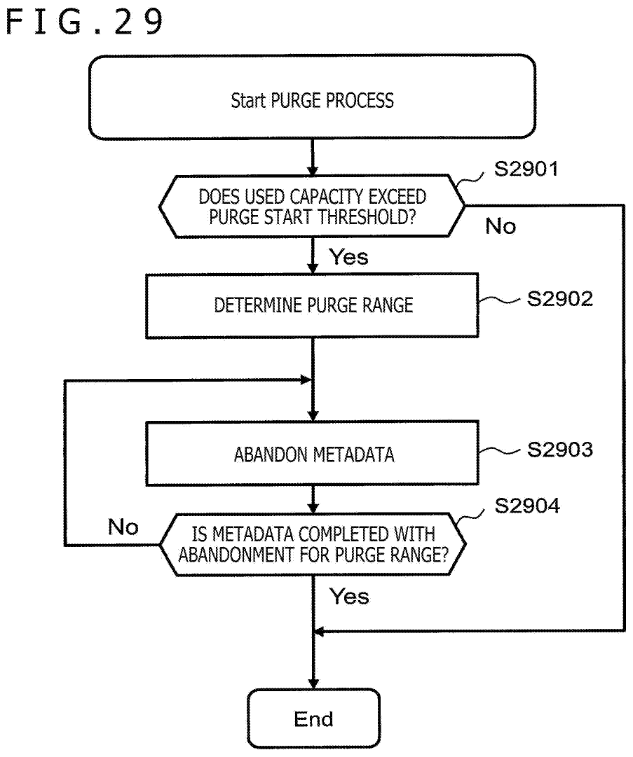

FIG. 29 depicts an example of a flow of the purge process. The purge process is performed on regular basis.

The purge program 319 determines whether a used capacity of the CDP metadata volume 450 exceeds a purge start threshold (Step S2901). It is noted that the purge start threshold is a threshold for managing the used capacity of the CDP metadata volume 450.

In a case in which a determination result of Step S2901 is False (Step S2901: NO), the purge program 319 ends the purge process.

In a case in which the determination result of Step S2901 is True (Step S2901: YES), the purge program 319 determines a purge range of the CDP metadata volume 450 (Step S2902). The purge range is, for example, a range exceeding a protection period designated by the user. Since the user is unable to perform deletion, update, and the like of past data in the protection period, the data is secure.

Subsequently, the purge program 319 abandons the oldest metadata 400 (Step S2903).

Subsequently, the purge program 319 determines whether the metadata 400 is completed with abandonment for the purge range (Step S2904).

In a case in which a determination result of Step S2904 is False (Step S2904: NO), the purge program 319 returns the process to Step S2903.

In a case in which the determination result of Step S2904 is True (Step 2904: YES), the purge program 319 ends the purge process.

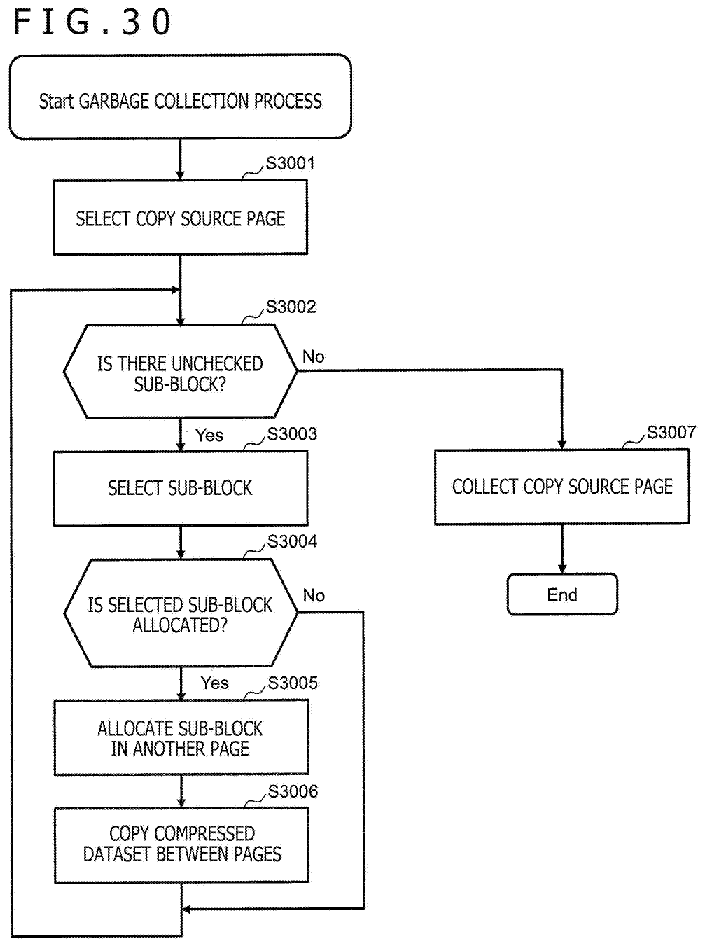

FIG. 30 depicts an example of a flow of the garbage collection process. The garbage collection process of FIG. 30 is a process for collecting additional write pages, and may be started, for example, on regular basis or in a case in which the pool capacity management program 316 determines that a ratio of a capacity of unallocated pages 461 to a capacity of the pool volume 440 is lower than a predetermined value.

The pool capacity management program 316 selects a page 461 (copy source page) to be used as a copy source in the garbage collection process (Step S3001).

The pool capacity management program 316 refers to the sub-block management table 327 corresponding to the additional write volume 740 to which the copy source page is allocated, and determines whether there is a sub-block 702 unchecked in the garbage collection process (Step S3002).

In a case in which a determination result of Step S3002 is True (Step S3002: YES), the pool capacity management program 316 moves the process to Step S3003, and selects one sub-block 702 out of the unchecked sub-blocks 702 (Step S3003).

In a case in which the allocation flag 1303 of the sub-block 702 selected in Step S3003 indicates “allocated” (Step S3004: YES), the pool capacity management program 316 allocates the sub-block 702 in the page 461 of a copy destination (Step S3005), and copies a compressed dataset to the sub-block 702 allocated in Step S3005 from the sub-block 702 selected in Step S3003 (Step S3006).

As a result of Step S3006, the reference source of the sub-block 702 of the copy source sets the sub-block 702 of the copy destination as a referent as an alternative to the sub-block 702 of the copy source. After Step S3006, the pool capacity management program 316 then returns the process to Step S3002.

In a case in which a determination result of Step S3002 is False (Step S3002: NO), that is, in a case in which enabled compressed datasets in the copy source page are all copied to the copy destination page 461, the pool capacity management program 316 collects the copy source page, that is, changes the information about the allocation flag 1202 of the copy source page to “unallocated” (Step S3007).

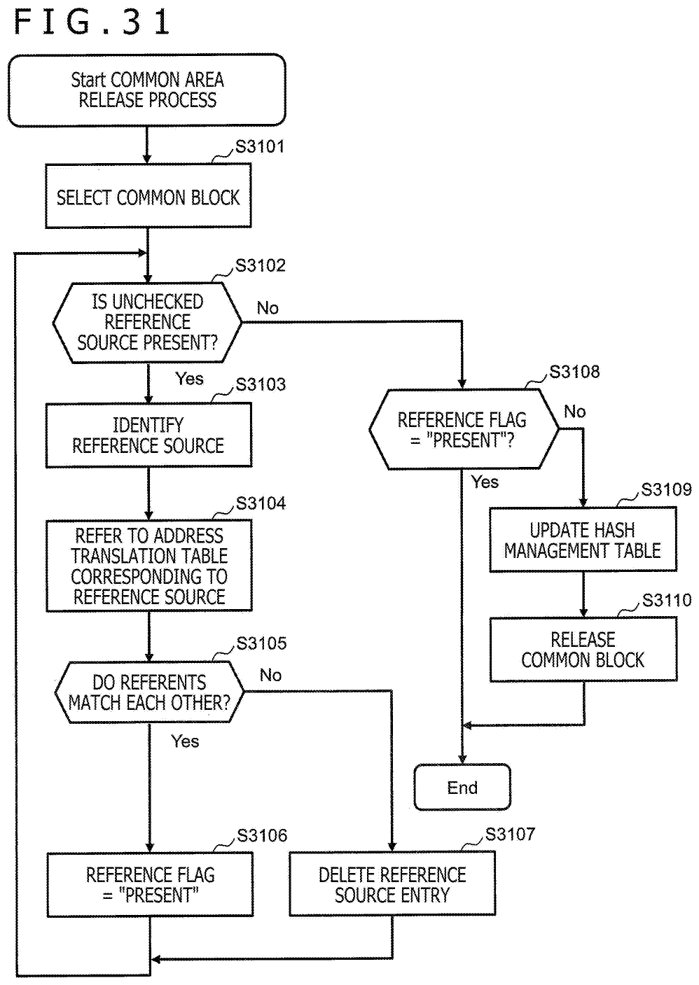

FIG. 31 depicts an example of a flow of the common area release process. The common area release process is performed, for example, on regular basis. In the common area release process, the common area check table 1900 corresponding to the to-be-processed common volume 730 may be created by the common area release program 317 or prepared in the shared memory 303 in advance.

The common area release program 317 selects any of the common blocks (Step S3101). The common block selected in Step S3101 will be referred to as “target common block.” The common area release program 317 refers to the duplication management table 330 and determines whether at least one reference source referring to the target common block is present (Step S3102).

In a case in which a determination result of Step S3102 is True (Step S3102: YES), the common area release program 317 moves the process to Step S3103 and identifies the reference source (Step S3103). More specifically, the common area release program 317 selects a reference source entry corresponding to the target common block from the duplication management table 330, and identifies the volume number and the logical address of the reference source from the selected reference source entry.

The common area release program 317 refers to the address translation table 322 corresponding to the reference source (Step S3104). More specifically, the common area release program 317 identifies the information (referent) about the referent VOL #902 and the referent VOL internal address 903 corresponding to the logical address identified in Step S3103, from the address translation table 322 corresponding to the VOL having the volume number identified in Step S3103.

In a case in which the referent identified in Step S3104 (block 701 identified by the information about the referent VOL #902 and the referent VOL internal address 903) matches the target common block (Step S3105: YES), the common area release program 317 sets the information about the reference flag 1902 corresponding to the target common block to (“present”) (Step S3106).

On the other hand, in a case in which the referent identified in Step S3104 does not match the target common block (Step S3105: NO), the common area release program 317 deletes reference source entry identified in Step S3103 from the reference source entry corresponding to the target common block (Step S3107).

In a case in which a plurality of reference source entries having the same normal volume 130 as the reference source are present for the target common block, the common area release program 317 may collectively execute Steps S3103 to S3107 for a plurality of logical addresses expressed by the plurality of reference source entries corresponding to the same normal volume 130.

In a case in which the determination result of Step S3102 is False (Step S3102: NO), Steps S3103 to S3107 have been executed for one or more reference source entries corresponding to the target common block, or no reference source entry corresponding to the target common block is present. In this case, the common area release program 317 determines whether the information about the reference flag 1902 corresponding to the target common block indicates (“present”) (Step S3108).

In a case in which a determination result of Step S3108 is False (Step S3108: NO), that is, in a case in which the information about the reference flag 1902 corresponding to the target common block indicates (“not present”), then no reference source using the target common block as the referent is present, and the common area release program 317, therefore, performs the process from Steps S3109 and S3110.

In other words, the common area release program 317 updates the hash management table 329 (Step S3109). More specifically, the common area release program 317 updates the information about the registration flag 1602 to (“not present”) and deletes the information about the VOL #1603 and the VOL internal address 1604 for the entry of the volume for which the information corresponding to the target common block is stored in the VOL #1603 and the VOL internal address 1604.

Moreover, the common area release program 317 releases the target common block to set the target common block to be “not in use” (Step S3110). More specifically, the common area release program 317 updates the information about the in-use flag 1802 corresponding to the target common block to “not in use.”

In a case in which the determination result of Step S3108 is True (Step S3108: YES), the process in Steps S3109 and S3110 is not performed. This is because at least one reference source using the target common block as the referent is present.

According to the common area release process described above, it is possible to detect the common block for which the reference source is not present any longer and to release the detected common block to set the common block to be “not in use.” It is thereby possible to increase a free capacity (number of free blocks) of the common volume 730.

According to the present embodiment, it is possible to provide a highly reliable storage system.

### (2) Other Embodiment

While a case of applying the present invention to the storage system has been described in the preceding embodiment, the present invention is not limited to the case and is widely applicable to various other systems, devices, methods, and programs.

Furthermore, the configuration of saving the metadata 400 (address translation table 322) for every write of the dirty data has been described in the preceding embodiment by way of example; however, the present invention is not limited to the example and may have a configuration of saving the metadata whenever a snapshot is taken. The present invention may have one of or both of the two configurations, that is, the former configuration and the configuration using the snapshot.

Moreover, information about the programs, the tables, the files, and the like for realizing the functions mentioned in the above description may be placed in a storage device such as a memory, a hard disk, or a solid state drive (SSD) or in a recording medium such as an IC card, an SD card, or a DVD.

The embodiment described above has, for example, the following characteristic configuration.

A storage system (for example, the storage system 201) capable of restoring a logical volume (for example, the normal volume 130 or the CDP volume 420), including: a data control section (for example, the CDP control program 318) that exercises control to additionally write data at a past point in time in the logical volume to a storage section (for example, the pool volume 110, the CDP data volume 430, or the pool volume 440); and a data management section (for example, the CDP control program 318) that manages metadata (for example, the metadata 121, the metadata 400, or the address translation table 322) about the data additionally written to the storage section by the data control section, the metadata being data for associating position information about the data in the logical volume with position information about the data in the storage section, and the data management section copying metadata at a predetermined point in time of issuance of a restore operation for the logical volume to the logical volume, and returning the logical volume into a state at the predetermined point in time (for example, performing the process in Step S2608).

With the configuration described above, operating the metadata enables the logical volume to be returned into the state of a past point in time without moving data in the logical volume; thus, it is possible to promptly recover data into a user's desired state even in a case, for example, of occurrence of a data failure. Furthermore, with the configuration described above, managing the metadata about past data makes it possible to restore the logical volume into a past other point in time even in a case, for example, in which a user restores the logical volume into a past certain point in time.

The data management section abandons metadata at and after the predetermined point in time on the basis of a restore definitive determination operation (for example, performs the process in Step S2703).

With the configuration described above, the metadata is held until the restore definitive determination operation, that is, the definitive determination standby state is provided; thus, the user can try to, for example, restore the logical volume into a state at a desired past point in time and to confirm the state of the logical volume. In other words, the user can validate the state of the logical volume at every past point in time until the restore definitive determination operation.

The data management section saves all associating data (for example, the latest address translation table 322) for associating the position information about the data in the logical volume with the position information about the data in the storage section at the predetermined point in time on the basis of the restore operation (performs, for example, the process in Step S2602).

With the configuration described above, even in a case, for example, in which the user restores the logical volume into a state at a predetermined point in time, it is possible to return the state of the logical volume into an original state by copying the saved associating data at the predetermined point in time to the logical volume.

The data management section abandons the associating data on the basis of a restore definitive determination operation (for example, performs the process in Step S2702).

In a case, for example, in which the user definitively determines the restore, the associating data at the predetermined point in time becomes unnecessary data; however, according to the configuration described above, it is possible to reduce a data volume by abandoning the associating data at the predetermined point in time.

The data management section copies the associating data to the logical volume and abandons the associating data on the basis of an operation to return the logical volume into a state before restoring the logical volume (for example, performs the process in Steps S2802 and S2803).

In a case, for example, in which the user returns the logical volume into a state before the logical volume is restored, the associating data at the predetermined point in time becomes unnecessary data; however, according to the configuration described above, it is possible to reduce the data volume by abandoning the associating data at the predetermined point in time.

The data control section additionally writes the data whenever the data is updated (for example, performs the process in Step S2208).

According to the configuration described above, continuously holding the data makes it possible to set the logical volume into a state at a past arbitrary point in time; thus, it is possible to promptly recover data into a user's desired state even in the case, for example, of occurrence of a data failure.

Furthermore, the configurations described above may be changed, recomposed, combined, or omitted as appropriate in a range within the gist of the present invention.

It is to be understood that items included in a list in a form of “at least one of A, B, and C” can be interpreted as (A), (B), (C), (A and B), (A and C), (B and C), or (A, B, and C). Likewise, items included in a list in a form of “at least A, B, or C” can be interpreted as (A), (B), (C), (A and B), (A and C), (B and C), or (A, B, and C).

What is claimed is:

1. A storage system capable of restoring a logical volume, comprising:
a data control section that exercises control to additionally write data at a past point in time in the logical volume to a storage section; and
a data management section that manages metadata about the data additionally written to the storage section by the data control section, wherein
the metadata is data for associating position information about the data in the logical volume with position information about the data in the storage section, and
the data management section copies metadata at a predetermined point in time of issuance of a restore operation for the logical volume to the logical volume, and returns the logical volume into a state at the predetermined point in time.

2. The storage system according to claim 1, wherein
the data management section abandons metadata at and after the predetermined point in time on a basis of a restore definitive determination operation.

3. The storage system according to claim 1, wherein
the data management section saves all associating data for associating the position information about the data in the logical volume with the position information about the data in the storage section at the predetermined point in time on a basis of the restore operation.

4. The storage system according to claim 3, wherein
the data management section abandons the associating data on a basis of a restore definitive determination operation.

5. The storage system according to claim 3, wherein
the data management section copies the associating data to the logical volume and abandons the associating data on the basis of an operation to return the logical volume into a state before restoring the logical volume.

6. The storage system according to claim 1, wherein
the data control section additionally writes the data whenever the data is updated.
